(19) United States
(12) Patent Application Publication
(10) Pub. No.: US 2015/0093665 A1
(43) Pub. Date: Apr. 2, 2015

(54) CATHODE COMBUSTION FOR ENHANCED FUEL CELL SYNGAS PRODUCTION

(71) Applicants: Timothy A. Barckholtz, Whitehouse Station, NJ (US); Paul J. Berlowitz, Glen Gardner, NJ (US)

(72) Inventors: Timothy A. Barckholtz, Whitehouse Station, NJ (US); Paul J. Berlowitz, Glen Gardner, NJ (US)

(73) Assignee: EXXONMOBIL RESEARCH AND ENGINEERING COMPANY, Annandale, NJ (US)

(21) Appl. No.: 14/486,177

(22) Filed: Sep. 15, 2014

Related U.S. Application Data
(63) Continuation-in-part of application No. 14/197,391, filed on Mar. 5, 2014.
Application No. 14/197,391 is a continuation-in-part of application No. 14/197,430, filed on Mar. 5, 2014.
Application No. 14/197,430 is a continuation-in-part of application No. 14/197,551, filed on Mar. 5, 2014.
Application No. 14/197,551 is a continuation-in-part of application No. 14/197,613, filed on Mar. 5, 2014.
Application No. 14/197,613 is a continuation-in-part of application No. 14/207,686, filed on Mar. 13, 2014.
Application No. 14/207,686 is a continuation-in-part of application No. 14/207,687, filed on Mar. 13, 2014.
Application No. 14/207,687 is a continuation-in-part of application No. 14/207,690, filed on Mar. 13, 2014.
Application No. 14/207,690 is a continuation-in-part of application No. 14/207,691, filed on Mar. 13, 2014.
Application No. 14/207,691 is a continuation-in-part of application No. 14/207,693, filed on Mar. 13, 2014.
Application No. 14/207,693 is a continuation-in-part of application No. 14/207,697, filed on Mar. 13, 2014.
Application No. 14/207,697 is a continuation-in-part of application No. 14/207,698, filed on Mar. 13, 2014.
Application No. 14/207,698 is a continuation-in-part of application No. 14/207,699, filed on Mar. 13, 2014.
Application No. 14/207,699 is a continuation-in-part of application No. 14/207,706, filed on Mar. 13, 2014.
Application No. 14/207,706 is a continuation-in-part of application No. 14/207,708, filed on Mar. 13, 2014.
Application No. 14/207,708 is a continuation-in-part of application No. 14/207,710, filed on Mar. 13, 2014.
Application No. 14/207,710 is a continuation-in-part of application No. 14/207,711, filed on Mar. 13, 2014.
Application No. 14/207,711 is a continuation-in-part of application No. 14/207,712, filed on Mar. 13, 2014.
Application No. 14/207,712 is a continuation-in-part of application No. 14/207,714, filed on Mar. 13, 2014.
Application No. 14/207,714 is a continuation-in-part of application No. 14/207,721, filed on Mar. 13, 2014.
Application No. 14/207,721 is a continuation-in-part of application No. 14/207,726, filed on Mar. 13, 2014.
Application No. 14/207,726 is a continuation-in-part of application No. 14/207,728, filed on Mar. 13, 2014.
Application No. 14/207,728 is a continuation-in-part of application No. 14/315,419, filed on Jun. 26, 2014.
Application No. 14/315,419 is a continuation-in-part of application No. 14/315,439, filed on Jun. 26, 2014.
Application No. 14/315,439 is a continuation-in-part of application No. 14/315,479, filed on Jun. 26, 2014.
Application No. 14/315,479 is a continuation-in-part of application No. 14/315,507, filed on Jun. 26, 2014.
Application No. 14/315,507 is a continuation-in-part of application No. 14/315,527, filed on Jun. 26, 2014.
(60) Provisional application No. 61/884,376, filed on Sep. 30, 2013.
(60) Provisional application No. 61/884,545, filed on Sep. 30, 2013.
(60) Provisional application No. 61/884,565, filed on Sep. 30, 2013.
(60) Provisional application No. 61/884,586, filed on Sep. 30, 2013.
(60) Provisional application No. 61/884,605, filed on Sep. 30, 2013.
(60) Provisional application No. 61/884,635, filed on Sep. 30, 2013.
(60) Provisional application No. 61/889,757, filed on Oct. 11, 2013.

(51) Int. Cl. H01M 8/06

(52) U.S. Cl. CPC H01M 8/0618
USPC 429/423

(57) ABSTRACT

Molten carbonate fuel cells are operated with a cathode inlet stream that contains a portion of a combustible gas which may be a hydrocarbon, hydrogen, or other gas that will combine with oxygen to form heat on the cathode catalyst surface. The combustible gases can be reacted in the cathode and/or in a stage that is heat integrated with the cathode. The heat generated by the combustion reaction in the cathode can be used, for example, to allow additional endothermic reactions (such as reforming) to take place in the anode portion of the fuel cell while still maintaining a desirable temperature gradient across the fuel cell. Optionally, the cathode of the fuel cell can be modified to further enhance or control the combustion within the cathode, such as by introducing an additional catalytic surface in the cathode.

### CROSS-REFERENCE TO RELATED APPLICATIONS

This application claims the benefit of provisional U.S. Ser. Nos. 61/884,376, 61/884,545, 61/884,565, 61/884,586, 61/884,605, and 61/884,635, all filed on Sep. 30, 2013, each of which is incorporated by reference herein in its entirety. This application further claims the benefit of provisional U.S. Ser. No. 61/889,757, filed on Oct. 11, 2013, which is incorporated by reference herein in its entirety. This application further claims priority as continuations-in-part of non-provisional U.S. Ser. Nos. 14/197,397, 14/197,430, 14/197,551, 14/197,613, 14/207,686, 14/207,687, 14/207,690, 14/207,691, 14/207,693, 14/207,697, 14/207,698, 14/207,699, 14/207,706, 14/207,708, 14/207,710, 14/207,711, 14/207,712, 14/207,714, 14/207,721, 14/207,726, and 14/207,728, all filed on Mar. 13, 2014, and to U.S. Ser. Nos. 14/315,419, 14/315,439, 14/315,479, 14/315,507, and 14/315,527, all filed on Jun. 26, 2014, each of which is incorporated by reference herein in its entirety.

This application is further related to two other co-pending U.S. applications, filed on even date herewith, and identified by the following Attorney Docket numbers and titles: 2013EM243-US entitled “Integrated Power Generation and Chemical Production using Solid Oxide Fuel Cells”; and 2013EM244-US entitled “Power Generation and CO₂ Capture with Turbines in Series”. Each of these co-pending U.S. applications is hereby incorporated by reference herein in its entirety.

### FIELD OF THE INVENTION

In various aspects, the invention is related to methods for operating molten carbonate fuel cells.

### BACKGROUND OF THE INVENTION

Molten carbonate fuel cells utilize hydrogen and/or other fuels to generate electricity. The hydrogen may be provided by reforming methane or other reformable fuels in a steam reformer that is upstream of the fuel cell or within the fuel cell. Reformable fuels can encompass hydrocarbonaceous materials that can be reacted with steam and/or oxygen at elevated temperature and/or pressure to produce a gaseous product that comprises hydrogen. Alternatively or additionally, fuel can be reformed in the anode cell in a molten carbonate fuel cell, which can be operated to create conditions that are suitable for reforming fuels in the anode. Alternately or additionally, the reforming can occur both externally and internally to the fuel cell.

Traditionally, molten carbonate fuel cells are operated to maximize electricity production per unit of fuel input, which may be referred to as the fuel cell's electrical efficiency. This maximization can be based on the fuel cell alone or in conjunction with another power generation system. In order to achieve increased electrical production and to manage the heat generation, fuel utilization within a fuel cell is typically maintained at 70% to 75%.

U.S. Patent Application Publication No. 2011/0111315 describes a system and process for operating fuel cell systems with substantial hydrogen content in the anode inlet stream. The technology in the '315 publication is concerned with providing enough fuel in the anode inlet so that sufficient fuel remains for the oxidation reaction as the fuel approaches the anode exit. To ensure adequate fuel, the '315 publication provides fuel with a high concentration of H₂. The H₂ not utilized in the oxidation reaction is recycled to the anode for use in the next pass. On a single pass basis, the H₂ utilization may range from 10% to 30%. The '315 reference does not describe significant reforming within the anode, instead relying primarily on external reforming.

U.S. Patent Application Publication No. 2005/0123810 describes a system and method for co-production of hydrogen and electrical energy. The co-production system comprises a fuel cell and a separation unit, which is configured to receive the anode exhaust stream and separate hydrogen. A portion of the anode exhaust is also recycled to the anode inlet. The operating ranges given in the '810 publication appear to be based on a solid oxide fuel cell. Molten carbonate fuel cells are described as an alternative.

U.S. Patent Application Publication No. 2003/0008183 describes a system and method for co-production of hydrogen and electrical power. A fuel cell is mentioned as a general type of chemical converter for converting a hydrocarbon-type fuel to hydrogen. The fuel cell system also includes an external reformer and a high temperature fuel cell. An embodiment of the fuel cell system is described that has an electrical efficiency of about 45% and a chemical production rate of about 25% resulting in a system coproduction efficiency of about 70%. The '183 publication does not appear to describe the electrical efficiency of the fuel cell in isolation from the system.

U.S. Pat. No. 5,084,362 describes a system for integrating a fuel cell with a gasification system so that coal gas can be used as a fuel source for the anode of the fuel cell. Hydrogen generated by the fuel cell is used as an input for a gasifier that is used to generate methane from a coal gas (or other coal) input. The methane from the gasifier is then used as at least part of the input fuel to the fuel cell. Thus, at least a portion of the hydrogen generated by the fuel cell is indirectly recycled to the fuel cell anode inlet in the form of the methane generated by the gasifier.

An article in the Journal of Fuel Cell Science and Technology (G. Manzolini et. al., J. Fuel Cell Sci. and Tech., Vol. 9, February 2012) describes a power generation system that combines a combustion power generator with molten carbonate fuel cells. Various arrangements of fuel cells and operating parameters are described. The combustion output from the combustion generator is used in part as the input for the cathode of the fuel cell. One goal of the simulations in the Manzolini article is to use the MCFC to separate CO₂ from the power generator's exhaust. The simulation described in the Manzolini article establishes a maximum outlet temperature of 660° C. and notes that the inlet temperature must be sufficiently cooler to account for the temperature increase across the fuel cell. The electrical efficiency (i.e., electricity generated/fuel input) for the MCFC fuel cell in a base model case is 50%. The electrical efficiency in a test model case, which is optimized for CO₂ sequestration, is also 50%.

An article by Desideri et al. (Intl. J. of Hydrogen Energy, Vol. 37, 2012) describes a method for modeling the performance of a power generation system using a fuel cell for CO₂ separation. Recirculation of anode exhaust to the anode inlet and the cathode exhaust to the cathode inlet are used to improve the performance of the fuel cell. The model parameters describe an MCFC electrical efficiency of 50.3%.

### SUMMARY OF THE INVENTION

In an aspect, a method for producing electricity is provided. The method includes introducing an anode fuel stream comprising a reformable fuel into an anode of a molten carbonate fuel cell, an internal reforming element associated with the anode of the molten carbonate fuel cell, or a combination thereof; introducing a cathode inlet stream comprising CO₂, O₂, and one or more fuel compounds into a cathode of the molten carbonate fuel cell, the one or more fuel compounds comprising H₂, one or more Hydrocarbonaceous fuel compounds, CO, or a combination thereof, a concentration of the one or more fuel compounds in the cathode inlet stream being at least about 0.01 vol %, the concentration of the one or more fuel compounds in the cathode inlet stream being less than an autoignition concentration for operating conditions in the cathode of the fuel cell; generating electricity within the molten carbonate fuel cell; generating an anode exhaust comprising H₂, CO, and CO₂; and generating a cathode exhaust comprising at least about 1 vol % O₂ and about 100 vppm or less of the one or more fuel compounds.

In another aspect, a method for producing electricity is provided. The method includes introducing an anode fuel stream comprising a reformable fuel into an anode of a molten carbonate fuel cell, an internal reforming element associated with the anode of the molten carbonate fuel cell, or a combination thereof; introducing a cathode inlet stream comprising CO₂, O₂, and one or more fuel compounds into a cathode of the molten carbonate fuel cell, the one or more fuel compounds comprising one or more aromatic compounds, one or more carbon-containing fuel compounds having at least 5 carbons, or a combination thereof, the one or more fuel compounds in the cathode inlet stream having a methylene-equivalent volume percentage (defined below) of at least about 0.02 vol %, the concentration of the one or more fuel compounds in the cathode inlet stream being less than an autoignition concentration for operating conditions in the cathode of the fuel cell; generating electricity within the molten carbonate fuel cell; generating an anode exhaust comprising H₂, CO, and CO₂; and generating a cathode exhaust comprising at least about 1 vol % O₂ and a methylene-equivalent volume percentage of about 0.01 vol % or less of the one or more fuel compounds, wherein the cathode of the molten carbonate fuel cell comprises an electrode surface and a secondary catalytic surface, the secondary catalytic surface comprising at least one Group VIII metal, the generating of the cathode exhaust comprising oxidizing at least a portion of the one or more fuel compounds in the presence of the secondary catalytic surface.

In still another aspect, a molten carbonate fuel cell system is provided. The molten carbonate fuel cell system includes a molten carbonate fuel cell having an anode and a cathode, the cathode comprising an electrode surface and a secondary catalytic surface comprising at least one Group VIII metal, a concentration of the at least one Group VIII metal on the secondary catalytic surface being lower in a first region of the secondary catalytic surface relative to a concentration of the at least one Group VIII metal in a second region of the secondary catalytic surface, the first region of the secondary catalytic surface being closer to a cathode inlet of the cathode of the molten carbonate fuel cell than the second region of the secondary catalytic surface. Optionally, the at least one Group VIII metal comprises Ni, Pt, Pd, Co, Rh, Ru, Re, Ir, Fe, or a combination thereof, preferably at least including Ni, Co, Fe, Pt, Pd, or a combination thereof. Optionally, a region of the secondary catalytic surface comprises a continuous increasing gradient of concentration of the at least one Group VIII metal. In some aspects, the first region of the secondary catalytic surface comprises at least one Group VIII metal and the second region of the secondary catalytic surface comprises at least one additional Group VIII metal different from the at least one Group VIII metal of the first region of the secondary catalytic surface. In other aspects, the second region of the secondary catalytic surface comprises at least one Group VIII metal and the first region of the secondary catalytic surface comprises at least one additional Group VIII metal different from the at least one Group VIII metal of the second region of the secondary catalytic surface.

### BRIEF DESCRIPTION OF THE FIGURES

FIG. 1 schematically shows an example of a configuration for molten carbonate fuel cells and associated reforming and separation stages.

FIG. 2 schematically shows another example of a configuration for molten carbonate fuel cells and associated reforming and separation stages.

FIG. 3 schematically shows an example of the operation of a molten carbonate fuel cell.

### DETAILED DESCRIPTION OF THE EMBODIMENTS

### Overview

In various aspects, molten carbonate fuel cells are operated with a cathode inlet stream that contains a non-trivial portion of a combustible gas which may be a hydrocarbon, hydrogen, or other gas that will combine with oxygen to form heat on the cathode catalyst surface. The combustible gases can be reacted in the cathode and/or in a stage that is heat integrated with the cathode. The heat generated by the combustion reaction in the cathode can be used, for example, to allow additional endothermic reactions (such as reforming) to take place in the anode portion of the fuel cell while still maintaining a desirable temperature gradient across the fuel cell. Optionally, the cathode of the fuel cell can be modified to further enhance or control the combustion within the cathode, such as by introducing an additional catalytic surface in the cathode.

One strategy for reducing or minimizing the amount of carbon emitted from a combustion source such as a gas turbine, internal combustion engine, fired boiler, or other combustion source, is to integrate the combustion source with a molten carbonate fuel cell (MCFC). The molten carbonate fuel cell can receive the CO₂-containing exhaust from the combustion source as part of the cathode inlet flow to the fuel cell. As part of the cathode reaction, CO₂ can be transported from the cathode across the fuel cell electrolyte to the anode. This can allow the molten carbonate fuel cell to assist with concentrating CO₂ in the anode output from the fuel cell, which can facilitate capturing/repurposing the CO₂ to avoid emission of the CO₂ to the atmosphere.

For a conventional molten carbonate fuel cell configuration, the primary concerns can be to operate the molten carbonate fuel cell with a high electrical efficiency while maintaining the temperature gradient across the fuel cell within a desired range. Part of the challenge during conventional operation can be avoiding an excessively high temperature gradient across the fuel cell due to the excess or waste heat generated within the fuel cell. When operating a molten carbonate fuel cell for high efficiency, typically the cell is operated near the maximum temperature rise that is permissible in the fuel cell as the net operation at high efficiency is exothermic.

During conventional operation of a molten carbonate fuel cell, the amount of combustible gas present as the cathode input stream enters the cathode can typically be less than about 100 vppm, such as less than about 10 vppm. Additionally, the combustible gas can typically correspond to compounds with a relatively low fuel value per molecule, such as H₂ or CH₄. Such amounts of combustibles produce an insignificant quantity of heat when reacted with oxygen on the cathode relative the heat production in the overall fuel cell system. For portions of a cathode input stream that are derived from the exhaust of a combustion source, the residual combustible material can reflect the fact that the exhaust was previously exposed to combustion conditions, which typically have been optimized to achieve substantially complete combustion of an input fuel. In some conventional configurations, a portion of the cathode input stream can also correspond to a recycled portion of the anode output stream. In such conventional configurations, the recycled portion of the anode output stream can typically be passed through a burner prior to entering the cathode, which can also result in substantially complete combustion of any fuels in the portion of the anode output stream.

Instead of operating a molten carbonate fuel cell in a conventional manner, a molten carbonate fuel cell can be operated with a cathode input stream that includes combustible material, such as one or more fuel compounds. A fuel compound can correspond to CO, H₂, CH₄, other hydrocarbons and/or hydrocarbonaceous compounds that can be combusted, or other compounds that can be combusted (oxidized) to generate heat. In some aspects, the cathode inlet stream can contain fuel compounds corresponding to CO, H₂, and/or CH₄. In other aspects, the cathode inlet stream can contain H₂ and/or carbon-containing fuel compounds having four or fewer carbon atoms. In still other aspects, a portion of the fuel compounds in a cathode inlet stream can correspond to aromatic compounds, or carbon-containing compounds having at least 5 carbon atoms, or a combination thereof.

The amount of combustible material in the cathode inlet stream can be characterized in a variety of manners. One option can be to use the volume percentage of total combustible material. Another option can be to weight the volume percentage of combustible material based on the number of carbons and/or the number of heavy atoms present in the combustible material. This latter option can account for the difference in fuel value between a compound such as hydrogen and a distillate boiling range molecule. Both might be present as a gas occupying a similar volume at the temperature at the cathode inlet, but the fuel value of the distillate boiling range molecule is significantly larger.

For example, one option can be to use a cathode inlet stream that contains (as a lower limit) at least about 0.01 vol % of one or more fuel compounds, or at least about 0.02 vol %, or at least about 0.03 vol %, or at least about 0.05 vol %, or at least about 0.1 vol %, or at least about 0.25 vol %, or at least about 0.5 vol %, or at least about 1.0 vol %, or at least about 1.5 vol %, or at least about 2.0 vol %, or at least about 2.5 vol %, or at least 3.0 vol %. Additionally or alternately, the cathode inlet stream can contain (as an upper limit) about 5.0 vol % or less of one or more fuel compounds, or about 4.0 vol % or less, or about 3.5 vol % or less, or about 3.0 vol % or less, or about 2.5 vol % or less. Each of the lower limits on the amount of the one or more fuel compounds in a cathode inlet stream is explicitly contemplated in combination with each of the upper limits on the amount of the one or more fuel compounds in a cathode inlet stream. The upper limit on the amount of combustible material can vary, but should be below the concentration that would allow autoignition of the cathode inlet stream under the conditions in the cathode, typically on the order of a few vol % depending on the composition of the compounds.

Additionally or alternately, another option for characterizing the amount of combustible material in the cathode inlet stream can be to weight the volume percentage of combustible material based on the number of carbons, or alternatively the number of heavy atoms, in the combustible material. The fuel value of a hydrocarbon is roughly proportional to the number of carbon atoms present in the hydrocarbon. With the exception of oxygen, any additional heteroatoms (i.e., non-hydrogen atoms or heavy atoms) present in a hydrocarbonaceous material also contribute in a roughly proportional manner. In order to account for the additional fuel value of larger fuel components, the volume percentage of a fuel component can be multiplied by the number of carbon atoms in a component, or alternatively the number of non-oxygen heavy atoms in a component, to generate a modified volume percentage. When the modified volume percentage is based only on the carbon atoms in the fuel components, the modified volume percentage is defined herein as a “methylene-equivalent” volume percentage for the fuel components. When the modified volume percentage is based on the non-oxygen heavy atoms in the fuel components, the modified volume percentage is defined herein as a “heavy-atom-equivalent” volume percentage for the fuel components. For the purposes of the definitions of methylene-equivalent volume percentage and heavy-atom-equivalent volume percentage, a hydrogen molecule is defined as having a carbon atom or heavy atom value of 0.5. A CO molecule is similarly defined as having a carbon atom or heavy atom value of 0.5. This reflects the fact that these compounds have some fuel value, but not as much fuel value as a hydrocarbonaceous compound.

In various aspects, the methylene-equivalent volume percentage in a cathode inlet stream can be at least about 0.01 vol % of one or more fuel compounds, or at least about 0.02 vol %, or at least about 0.03 vol %, or at least about 0.05 vol %, or at least about 0.1 vol %, or at least about 0.25 vol %, or at least about 0.5 vol %, or at least about 1.0 vol %, or at least about 1.5 vol %, or at least about 2.0 vol %, or at least about 2.5 vol %, or at least 3.0 vol %. Additionally or alternately, the cathode inlet stream can contain about 5.0 vol % or less of one or more fuel compounds, or about 4.0 vol % or less, or about 3.5 vol % or less, or about 3.0 vol % or less, or about 2.5 vol % or less. Each of the lower limits on the methylene-equivalent volume percentage of the one or more fuel compounds in a cathode inlet stream is explicitly contemplated in combination with each of the upper limits on the methylene-equivalent volume percentage of the one or more fuel compounds in a cathode inlet stream. As an example of calculating a methylene-equivalent volume percentage, a hypothetical cathode inlet feed could contain fuel compounds corresponding to 0.02 vol % of ethylene and 0.01 vol % of H₂. In such a hypothetical example, the methylene-equivalent volume percentage for the feed would be 0.045 vol %. Ethylene contains two carbon atoms per molecule, so the ethylene would contribute 0.02×2=0.04 vol % to the total methylene-equivalent volume percentage. H₂ is defined as counting as 0.5 carbon atoms per molecule, so the H₂ would contribute 0.01×0.5=0.005 vol % to the total methylene-equivalent volume percentage.

Additionally or alternately, still another option for characterizing the amount of combustible material in the cathode inlet stream can be based on the relative energy value of fuel delivered to the cathode inlet compared with the energy value of fuel delivered to the corresponding anode inlet of the molten carbonate fuel cell. The amount of fuel in the cathode inlet stream can have about 12% or less of the energy value of the anode inlet stream, or about 10% or less, or about 8% or less. For example, if the rate of fuel delivered to the anode inlet corresponds to a power of about 1 MW, the rate of fuel input into the cathode in the cathode inlet stream can be about 120 kW or less, or about 100 kW or less, or about 80 kW or less. The cathode inlet stream can also contain sufficient oxygen so that, after combustion of any fuels in the cathode inlet stream, the remaining oxygen content is sufficient to enable the fuel cell reaction and still generate a cathode outlet stream having an oxygen content of at least about 1 vol %, such as 2 vol %.

In some aspects, a cathode inlet stream containing one or more fuel compounds can be have a reduced or minimized content of sulfur. The sulfur content of the cathode inlet stream can be about 25 wppm or less, or about 15 wppm or less, or about 10 wppm or less. Optionally, some heteroatoms different from C, H, and O can be present in oxidizable compounds (i.e., fuel compounds) contained in the cathode inlet stream. For example, carbon-containing fuel compounds in the cathode inlet stream can optionally include nitrogen atoms. It is noted that N₂ is not an oxidizable compound under the conditions present in the cathode inlet, and therefore the presence of N₂ in the cathode inlet stream does not constitute a heteroatom present in an oxidizable compound. In other aspects, the cathode inlet stream can include about 100 wppm or less of heteroatoms different from C, H, and O in fuel compounds, or about 10 wppm or less.

The additional fuel content in the cathode inlet stream can be combusted in the cathode based on the conditions in the cathode and the presence of a catalytic surface in the cathode. One suitable catalytic surface can be a nickel surface, such as the nickel surface that is often used as the electrode adjacent to the molten carbonate electrolyte, however, any other convenient catalyst that can oxidize the fuel components catalytically such as a group VIII metal, supported catalyst or other combustion catalyst may be used. The cathode electrode surface can catalyze oxidation of H₂ and/or carbon-containing fuels (including CO) so that fuel present in the cathode inlet stream can be converted to typical combustion products, such as H₂O and CO₂.

In aspects where the fuel in the cathode inlet stream is H₂, CO, and/or CH₄, the electrode surface (typically Ni) can be sufficient to catalyze the combustion of the fuel in the cathode inlet stream. The electrode surface can also be suitable for catalyzing the reaction for lower amounts of other hydrocarbons. For example, the electrode surface can be suitable for catalyzing the oxidation of aromatic compounds on the order of tens of ppm or higher, such as about 10 vppm to about 10,000 vppm, or about 10 vppm to about 1000 vppm, or about 10 vppm to about 200 vppm, or about 10 vppm to about 100 vppm, or about 50 vppm to about 10,000 vppm, or about 50 vppm to about 1000 vppm, or about 50 vppm to about 200 vppm, or about 100 vppm to about 10,000 vppm, or about 100 vppm to about 1000 vppm. For aliphatic hydrocarbons or other non-aromatic hydrocarbonaceous compounds, the electrode surface can be suitable for catalyzing up to about 1 vol % of the compounds.

In some aspects, the catalytic activity for oxidizing fuels in the cathode can be enhanced by providing an additional catalytic surface. For example, one configuration for a conventional molten carbonate fuel cell can be to have the cathode portion of the fuel cell defined by parallel plates. One parallel plate can correspond to the electrode surface that is adjacent to the molten carbonate electrolyte. Conventionally, the opposing surface (the surface not proximate to the molten carbonate electrolyte) can be a steel surface or another surface corresponding to a suitable structural material. Instead of having a steel surface (or other low reactivity surface) opposite from the electrode, the opposing surface can be coated with a catalytic material to enhance the ability to catalyze the combustion of the fuel in the cathode inlet stream. One option can be to provide a surface similar to the electrolyte surface, such as a Ni surface. Another option can be to use a surface with higher activity for catalyzing combustion of aromatic compounds and/or C2+ hydrocarbonaceous compounds. Examples of suitable catalytic materials can include, but are not limited to, Group VIII metals such as Ni, Fe, Co, Pt, and/or Pd. Any suitable metal or metal alloy can be used, either directly on the steel surface, or supported on a typical catalyst support. Catalyst formulations useful as combustion catalysts are well known in the art and any formulation suitable for the fuel cell operating temperature range (such as about 400° C. to about 800° C.) may be used. Alloys of Group VIII metals can also be suitable, such as alloys of multiple Group VIII metals and/or alloys of Group VIII metals with other transition metals. The catalytic material can be coated directly on the plate surface of the cathode, or the catalytic material can be support on, for example, an oxide support.

Based on the presence of the electrode (Ni) surface and/or the additional catalytic surface, the H₂, CO, and hydrocarbons/hydrocarbonaceous compounds in the cathode inlet stream can be combusted in the cathode. This will generate additional heat within the cathode. In conventional operation, this additional heat would pose difficulties as operations optimized for electrical efficiency are typically operated at the limit of permissible temperature rise. However, in various aspects, the additional heat generated in the cathode can be used to provide additional heat for an endothermic reaction. The endothermic reaction can correspond to reforming in the anode, or to another endothermic reaction that takes place in a reaction stage that is heat integrated with cathode. For example, when the anode portion of a molten carbonate fuel cell is operated to have a low single pass fuel utilization for production of hydrogen and/or syngas, the additional heat generated in the cathode can be used to maintain the temperature gradient within the fuel cell in a desired range.

Although the additional heat generated in the cathode can be beneficial, it can be desirable to distribute combustion of the fuel in the cathode inlet stream across a larger portion of the length of the cathode. One method for distributing the combustion of fuel in the cathode inlet stream across a larger portion of the cathode can be to use an additional catalytic surface that has a gradient of catalytic material. For example, the concentration of catalytic material on the additional catalytic surface can be lower near the entrance to the cathode (where concentrations of both the combustible material and oxygen are highest) and then subsequently increase over the length of the cathode. Any convenient strategy for increasing the concentration can be used, such as a continuous gradient, a series of step increases, or other methods for allowing higher catalytic material concentrations to be present at locations farther from the cathode inlet. The initial concentration of catalytic material on the additional surface at the cathode inlet can be any convenient value, including the option of having the catalytic material on the additional surface start at a location after the inlet to the cathode. The pattern or gradient of the catalyst, and the subsequent heat release, can be optimized so as to spread the total heat production out across the cathode area and prevent hot zones that could damage overall fuel cell operation.

As an example of a method for operating a molten carbonate fuel cell to take advantage of additional heat generated in the cathode, a molten carbonate fuel cell can be operated with increased production of syngas and/or hydrogen. This can be accomplished by increasing the amount of reforming performed within the fuel cell (and/or within an associated internal reforming stage, such as a reforming stage in a fuel cell assembly) relative to the amount of hydrogen oxidized in the anode to generate electricity. As henceforth defined, this can be accomplished by operation of the fuel cell with a fuel cell thermal ratio relating the combined a) heat produced within the anode by electrochemical reactions and b) heat produced within the cathode by combustion of fuels to c) the heat consumed within a fuel cell stack (or other fuel cell assembly) by endothermic reactions. For example, the reforming reaction within the anode and/or an internal reforming stage can typically be an endothermic reaction. Thus, the endothermic reforming reaction can be balanced by the exothermic electrochemical reaction for electricity generation in combination with the exothermic cathode combustion reaction. Rather than attempting to transport the heat generated by the exothermic fuel cell reaction(s) away from the fuel cell, this excess heat can be used in situ as a heat source for reforming and/or another endothermic reaction. This can result in more efficient use of the heat energy and/or a reduced need for additional external or internal heat exchange. This efficient production and use of heat energy, essentially in-situ, can reduce system complexity and components while maintaining advantageous operating conditions. In some aspects, the amount of reforming or other endothermic reaction can be selected to have an endothermic heat requirement comparable to, or even greater than, the amount of excess heat generated by the exothermic reaction(s) rather than significantly less than the heat requirement typically described in the prior art.

Additionally or alternately, the fuel cell can be operated so that the temperature differential between the anode inlet and the anode outlet can be negative rather than positive. Thus, instead of having a temperature increase between the anode inlet and the anode outlet, a sufficient amount of reforming and/or other endothermic reaction can be performed to cause the output stream from the anode outlet to be cooler than the anode inlet temperature. Further additionally or alternately, additional fuel can be supplied to a heater for the fuel cell and/or an internal reforming stage (or other internal endothermic reaction stage) so that the temperature differential between the anode input and the anode output can be smaller than the expected difference based on the relative demand of the endothermic reaction(s) and the combined exothermic heat generation of the cathode combustion reaction and the anode reaction for generating electrical power. In aspects where reforming can be used as the endothermic reaction, operating a fuel cell to reform excess fuel can allow for production of increased synthesis gas and/or increased hydrogen relative to conventional fuel cell operation while minimizing the system complexity for heat exchange and reforming. The additional synthesis gas and/or additional hydrogen can then be used in a variety of applications, including chemical synthesis processes and/or collection/repurposing of hydrogen for use as a “clean” fuel.

The amount of heat generated per mole of hydrogen oxidized by the exothermic reaction at the anode can be substantially larger than the amount of heat consumed per mole of hydrogen generated by the reforming reaction. The net reaction for hydrogen in a molten carbonate fuel cell (H₂+½O₂=>H₂O) can have an enthalpy of reaction of about −285 kJ/mol of hydrogen molecules. At least a portion of this energy can be converted to electrical energy within the fuel cell. However, the difference (approximately) between the enthalpy of reaction and the electrical energy produced by the fuel cell can become heat within the fuel cell. This quantity of energy can alternatively be expressed as the current density (current per unit area) for the cell multiplied by the difference between the theoretical maximum voltage of the fuel cell and the actual voltage, or <current density>*(Vmax−Vact). This quantity of energy is defined as the “waste heat” for a fuel cell. As an example of reforming, the enthalpy of reforming for methane (CH₄+2H₂O=>4H₂+CO₂) can be about 250 kJ/mol of methane, or about 62 kJ/mol of hydrogen molecules. From a heat balance standpoint, each hydrogen molecule electrochemically oxidized can generate sufficient heat to generate more than one hydrogen molecule by reforming. In a conventional configuration, this excess heat can result in a substantial temperature difference from anode inlet to anode outlet. Instead of allowing this excess heat to be used for increasing the temperature in the fuel cell, the excess heat can be consumed by performing a matching amount of the reforming reaction. The excess heat generated in the anode can be supplemented with the excess heat generated by the combustion reaction in the fuel cell. More generally, the excess heat can be consumed by performing an endothermic reaction in the fuel cell anode and/or in an endothermic reaction stage heat integrated with the fuel cell.

Depending on the aspect, the amount of reforming and/or other endothermic reaction can be selected relative to the amount of hydrogen reacted in the anode in order to achieve a desired thermal ratio for the fuel cell. As used herein, the “thermal ratio” is defined as the heat produced by exothermic reactions in a fuel cell assembly (including exothermic reactions in both the anode and cathode) divided by the endothermic heat demand of reforming reactions occurring within the fuel cell assembly. Expressed mathematically, the thermal ratio (TH)=Q_{EX}/Q_{EN}, where Q_{EX} is the sum of heat produced by exothermic reactions and Q_{EN} is the sum of heat consumed by the endothermic reactions occurring within the fuel cell. Note that the heat produced by the exothermic reactions can correspond to any heat due to reforming reactions, water gas shift reactions, combustion reactions (e.g., oxidation of fuel compounds) in the cathode, and/or the electrochemical reactions in the cell. The heat generated by the electrochemical reactions can be calculated based on the ideal electrochemical potential of the fuel cell reaction across the electrolyte minus the actual output voltage of the fuel cell. For example, the ideal electrochemical potential of the reaction in a MCFC is believed to be about 1.04V based on the net reaction that occurs in the cell. During operation of the MCFC, the cell can typically have an output voltage less than 1.04 V due to various losses. For example, a common output/operating voltage can be about 0.7 V. The heat generated can be equal to the electrochemical potential of the cell (i.e., ˜1.04V) minus the operating voltage. For example, the heat produced by the electrochemical reactions in the cell can be ˜0.34 V when the output voltage of ˜0.7V is attained in the fuel cell. Thus, in this scenario, the electrochemical reactions would produce ˜0.7 V of electricity and ˜0.34 V of heat energy. In such an example, the ˜0.7 V of electrical energy is not included as part of Q_{EX}. In other words, heat energy is not electrical energy.

In various aspects, a thermal ratio can be determined for any convenient fuel cell structure, such as a fuel cell stack, an individual fuel cell within a fuel cell stack, a fuel cell stack with an integrated reforming stage, a fuel cell stack with an integrated endothermic reaction stage, or a combination thereof. The thermal ratio may also be calculated for different units within a fuel cell stack, such as an assembly of fuel cells or fuel cell stacks. For example, the thermal ratio may be calculated for a fuel cell (or a plurality of fuel cells) within a fuel cell stack along with integrated reforming stages and/or integrated endothermic reaction stage elements in sufficiently close proximity to the fuel cell(s) to be integrated from a heat integration standpoint.

From a heat integration standpoint, a characteristic width in a fuel cell stack can be the height of an individual fuel cell stack element. It is noted that the separate reforming stage and/or a separate endothermic reaction stage could have a different height in the stack than a fuel cell. In such a scenario, the height of a fuel cell element can be used as the characteristic height. In this discussion, an integrated endothermic reaction stage can be defined as a stage heat integrated with one or more fuel cells, so that the integrated endothermic reaction stage can use the heat from the fuel cells as a heat source for reforming Such an integrated endothermic reaction stage can be defined as being positioned less than 10 times the height of a stack element from fuel cells providing heat to the integrated stage. For example, an integrated endothermic reaction stage (such as a reforming stage) can be positioned less than 10 times the height of a stack element from any fuel cells that are heat integrated, or less than 8 times the height of a stack element, or less than 5 times the height of a stack element, or less than 3 times the height of a stack element. In this discussion, an integrated reforming stage and/or integrated endothermic reaction stage that represents an adjacent stack element to a fuel cell element is defined as being about one stack element height or less away from the adjacent fuel cell element.

A thermal ratio of about 1.3 or less, or about 1.15 or less, or about 1.0 or less, or about 0.95 or less, or about 0.90 or less, or about 0.85 or less, or about 0.80 or less, or about 0.75 of less, can be lower than the thermal ratio typically sought in use of MCFC fuel cells. In aspects of the invention, the thermal ratio can be reduced to increase and/or optimize syngas generation, hydrogen generation, generation of another product via an endothermic reaction, or a combination thereof.

In various aspects of the invention, the operation of the fuel cells can be characterized based on a thermal ratio. Where fuel cells are operated to have a desired thermal ratio, a molten carbonate fuel cell can be operated to have a thermal ratio of about 1.5 or less, for example about 1.3 or less, or about 1.15 or less, or about 1.0 or less, or about 0.95 or less, or about 0.90 or less, or about 0.85 or less, or about 0.80 or less, or about 0.75 or less. Additionally or alternately, the thermal ratio can be at least about 0.25, or at least about 0.35, or at least about 0.45, or at least about 0.50. Further additionally or alternately, in some aspects the fuel cell can be operated to have a temperature rise between anode input and anode output of about 40° C. or less, such as about 20° C. or less, or about 10° C. or less. Still further additionally or alternately, the fuel cell can be operated to have an anode outlet temperature that is from about 10° C. lower to about 10° C. higher than the temperature of the anode inlet. Yet further additionally or alternately, the fuel cell can be operated to have an anode inlet temperature greater than the anode outlet temperature, such as at least about 5° C. greater, or at least about 10° C. greater, or at least about 20° C. greater, or at least about 25° C. greater. Still further additionally or alternately, the fuel cell can be operated to have an anode inlet temperature greater than the anode outlet temperature by about 100° C. or less, or about 80° C. or less, or about 60° C. or less, or about 50° C. or less, or about 40° C. or less, or about 30° C. or less, or about 20° C. or less.

Several operational parameters may be manipulated to generate a desired thermal ratio. Some parameters are similar to those currently recommended for fuel cell operation. Parameters that are manipulated in a way that differs from conventional operation can include the amount of fuel provided to the anode; the composition of the fuel provided to the anode; the amount of fuel compounds included in the cathode inlet stream; and/or the separation and capture of syngas in the anode output without significant recycling to the anode input, such as with no recycle of syngas or hydrogen from the anode output to the anode input.

Reforming of a hydrocarbon to form hydrogen and carbon oxides is an example of an endothermic reaction. Reforming is also an example of a reaction that can be performed within the anode and/or in an integrated reaction stage. In some aspects of the invention, the amount of fuel input to the anode can include more reformable fuel than an amount of reformable fuel used during conventional fuel cell operation. In such aspects, a goal can be to generate excess syngas through reformation in the anode and/or in an associated reforming stage in the fuel cell assembly containing the anode. In one aspect, the amount of reformable fuel introduced in the anode (or associated reforming stage or combination thereof) can be selected based on the amount of reforming the fuel cell is capable of, given the physical limitations of the particular fuel cell and other selected operational parameters. For example, the anode catalyst can contribute to the reformation process. The amount of surface area on the anode catalyst may be a constraint for the amount of reformation that can occur. Similarly, the amount of reformation may be limited by the amount of heat available within the anode and a temperature change that occurs across the anode.

Operating a fuel cell with a thermal ratio of less than 1 can cause a temperature drop across the fuel cell. In some aspects, the amount of reforming and/or other endothermic reaction may be limited so that a temperature drop from the anode inlet to the anode outlet can be about 100° C. or less, such as about 80° C. or less, or about 60° C. or less, or about 50° C. or less, or about 40° C. or less, or about 30° C. or less, or about 20° C. or less. Limiting the temperature drop from the anode inlet to the anode outlet can be beneficial, for example, for maintaining a sufficient temperature to allow complete or substantially complete conversion of fuels (by reforming) in the anode. In other aspects, additional heat can be supplied to the fuel cell (such as by heat exchange or combustion of additional fuel) so that the anode inlet temperature is greater than the anode outlet temperature by less than about 100° C. or less, such as about 80° C. or less, or about 60° C. or less, or about 50° C. or less, or about 40° C. or less, or about 30° C. or less, or about 20° C. or less, due to a balancing of the heat consumed by the endothermic reaction and the additional external heat supplied to the fuel cell.

The amount of reforming and/or other endothermic reaction may additionally or alternately be limited by the operational temperature of the fuel cell. For example, in general, reforming of fuel can occur more quickly at higher temperatures. In addition, more reforming can occur when more heat is available for the reforming process. As mentioned, aspects of the present invention may operate within a typical range of fuel cell temperatures. The temperature range may be selected for a variety of reasons that are separate from considerations related to aspects of the present invention. For example, a cathode or anode inlet stream may already be heated to a high temperature because of the source of the stream. Such a cathode inlet stream may allow for generation of additional heat based on combustion of fuels in the cathode inlet stream in the cathode. Additionally or alternately, a fuel cell electrolyte temperature can be maintained at a temperature that is sufficient so that the carbonate electrolyte remains in a molten state. Whatever temperature is chosen can impact the amount of reformation that can occur in the anode and may require the amount of reformable fuel input to the anode to be adjusted accordingly.

The amount of reforming can additionally or alternately be dependent on the availability of a reformable fuel. For example, if the fuel only comprised H₂, no reformation would occur because H₂ is already reformed and is not further reformable. The amount of “syngas produced” by a fuel cell can be defined as a difference in the LVH value of syngas in the anode input versus an LVH value of syngas in the anode output. Syngas produced LHV (sg net)=(LHV(sg out)−LHV(sg in)), where LHV(sg in) and LHV(sg out) refer to the LHV of the syngas in the anode inlet and syngas in the anode outlet streams or flows, respectively. A fuel cell provided with a fuel containing substantial amounts of H₂ can be limited in the amount of potential syngas production, since the fuel contains substantial amounts of already reformed H₂, as opposed to containing additional reformable fuel.

An example of a method for operating a fuel cell with a reduced thermal ratio as described above can be a method where excess reforming of fuel is performed in order to balance the generation and consumption of heat in the fuel cell and/or consume more heat than is generated. Reforming a reformable fuel to form H₂ and/or CO can be an endothermic process, while the anode electrochemical oxidation reaction and the cathode combustion reaction(s) can be exothermic. During conventional fuel cell operation, the amount of reforming needed to supply the feed components for fuel cell operation can typically consume less heat than the amount of heat generated by the anode oxidation reaction. For example, conventional operation at a fuel utilization of about 70% or about 75% produces a thermal ratio substantially greater than 1, such as a thermal ratio of at least about 1.4 or greater, or 1.5 or greater. As a result, the output streams for the fuel cell can be hotter than the input streams. Instead of this type of conventional operation, the amount of fuel reformed in the reforming stages associated with the anode can be increased. For example, additional fuel can be reformed so that the heat generated by the exothermic fuel cell reactions can either be (roughly) balanced by the heat consumed in reforming and/or consume more heat than is generated. This can result in a substantial excess of hydrogen relative to the amount oxidized in the anode for electrical power generation and result in a thermal ratio of about 1.0 or less, such as about 0.95 or less, or about 0.90 or less, or about 0.85 or less, or about 0.80 or less, or about 0.75 or less.

In aspects of the invention, the thermal ratio may be selected based on a desired temperature decrease across the fuel cell. Some fuel cells may have physical aspects that can be damaged when greater than a threshold temperature difference exists between the inlet and the outlet. The temperature decrease may be calculated by measuring the heat transfer by the bulk streams (e.g., anode inlet, anode outlet, cathode inlet, and cathode outlet). The temperature decrease can be a function of the total heat consumed in endothermic reactions, heat released in the exothermic reactions, heat loss through the fuel cell hardware, and any heat added directly to the fuel cell apart from the bulk streams. The heat loss through the fuel cell hardware can be an estimated value.

In contrast to the operating conditions described above for maximum electricity generation, operating the fuel cell with an thermal ratio below about 1.3 or less, such as about 1.0 or less, or about 0.95 or less, or about 0.90 or less, or about 0.85 or less, or about 0.80 or less, or about 0.75 or less can allow for production of additional syngas. This means an increased amount of a chemical energy product can optionally be withdrawn from the fuel cell output. The excess hydrogen generated by operating at a thermal ratio below about 1.3 or less can, for example, be separated out from the anode output flow and used as a fuel with no greenhouse gas emissions. Alternatively, a water-gas shift reaction can be used to balance the amount of hydrogen and CO present in the anode output for use as a syngas having a desired syngas composition, such as a desired ratio of H₂ to CO.

Either hydrogen or syngas can be withdrawn from the anode exhaust as a chemical energy output. Hydrogen can be used as a clean fuel without generating greenhouse gases when it is burned or combusted. Instead, for hydrogen generated by reforming of hydrocarbons (or hydrocarbonaceous compounds), the CO₂ will have already been “captured” in the anode loop. Additionally, hydrogen can be a valuable input for a variety of refinery processes and/or other synthesis processes. Syngas can also be a valuable input for a variety of processes. In addition to having fuel value, syngas can be used as a feedstock for producing other higher value products, such as by using syngas as an input for Fischer-Tropsch synthesis and/or methanol synthesis processes.

### Additional Fuel Cell Operation Strategies

As an addition, complement, and/or alternative to the fuel cell operating strategies described herein, a molten carbonate fuel cell (such as a fuel cell assembly) can be operated at a reduced fuel utilization value, such as a fuel utilization of about 50% or less, while also having a high CO₂ utilization value, such as at least about 60%. In this type of configuration, the molten carbonate fuel cell can be effective for carbon capture, as the CO₂ utilization can advantageously be sufficiently high. Rather than attempting to maximize electrical efficiency, in this type of configuration the total efficiency of the fuel cell can be improved or increased based on the combined electrical and chemical efficiency. The chemical efficiency can be based on withdrawal of a hydrogen and/or syngas stream from the anode exhaust as an output for use in other processes. Even though the electrical efficiency may be reduced relative to some conventional configurations, making use of the chemical energy output in the anode exhaust can allow for a desirable total efficiency for the fuel cell.

In various aspects, the fuel utilization in the fuel cell anode can be about 50% or less, such as about 40% or less, or about 30% or less, or about 25% or less, or about 20% or less. In various aspects, in order to generate at least some electric power, the fuel utilization in the fuel cell can be at least about 5%, such as at least about 10%, or at least about 15%, or at least about 20%, or at least about 25%, or at least about 30%. Additionally or alternatively, the CO₂ utilization can be at least about 60%, such as at least about 65%, or at least about 70%, or at least about 75%.

In some aspects, the reformable hydrogen content of reformable fuel in the input stream delivered to the anode and/or to a reforming stage associated with the anode can be at least about 50% greater than the net amount of hydrogen reacted at the anode, such as at least about 75% greater or at least about 100% greater. Additionally or alternately, the reformable hydrogen content of fuel in the input stream delivered to the anode and/or to a reforming stage associated with the anode can be at least about 50% greater than the net amount of hydrogen reacted at the anode, such as at least about 75% greater or at least about 100% greater. In various aspects, a ratio of the reformable hydrogen content of the reformable fuel in the fuel stream relative to an amount of hydrogen reacted in the anode can be at least about 1.5:1, or at least about 2.0:1, or at least about 2.5:1, or at least about 3.0:1. Additionally or alternately, the ratio of reformable hydrogen content of the reformable fuel in the fuel stream relative to the amount of hydrogen reacted in the anode can be about 20:1 or less, such as about 15:1 or less or about 10:1 or less. In one aspect, it is contemplated that less than 100% of the reformable hydrogen content in the anode inlet stream can be converted to hydrogen. For example, at least about 80% of the reformable hydrogen content in an anode inlet stream can be converted to hydrogen in the anode and/or in an associated reforming stage(s), such as at least about 85%, or at least about 90%. Additionally or alternately, the amount of reformable fuel delivered to the anode can be characterized based on the Lower Heating Value (LHV) of the reformable fuel relative to the LHV of the hydrogen oxidized in the anode. This can be referred to as a reformable fuel surplus ratio. In various aspects, the reformable fuel surplus ratio can be at least about 2.0, such as at least about 2.5, or at least about 3.0, or at least about 4.0. Additionally or alternately, the reformable fuel surplus ratio can be about 25.0 or less, such as about 20.0 or less, or about 15.0 or less, or about 10.0 or less.

As an addition, complement, and/or alternative to the fuel cell operating strategies described herein, a molten carbonate fuel cell (such as a fuel cell assembly) can also be operated at conditions that can improve or optimize the combined electrical efficiency and chemical efficiency of the fuel cell. Instead of selecting conventional conditions for maximizing the electrical efficiency of a fuel cell, the operating conditions can allow for output of excess synthesis gas and/or hydrogen in the anode exhaust of the fuel cell. The synthesis gas and/or hydrogen can then be used in a variety of applications, including chemical synthesis processes and collection of hydrogen for use as a “clean” fuel. In aspects of the invention, electrical efficiency can be reduced to achieve a high overall efficiency, which includes a chemical efficiency based on the chemical energy value of syngas and/or hydrogen produced relative to the energy value of the fuel input for the fuel cell.

In some aspects, the operation of the fuel cells can be characterized based on electrical efficiency. Where fuel cells are operated to have a low electrical efficiency (EE), a molten carbonate fuel cell can be operated to have an electrical efficiency of about 40% or less, for example, about 35% EE or less, about 30% EE or less, about 25% EE or less, or about 20% EE or less, about 15% EE or less, or about 10% EE or less. Additionally or alternately, the EE can be at least about 5%, or at least about 10%, or at least about 15%, or at least about 20%. Further additionally or alternately, the operation of the fuel cells can be characterized based on total fuel cell efficiency (TFCE), such as a combined electrical efficiency and chemical efficiency of the fuel cell(s). Where fuel cells are operated to have a high total fuel cell efficiency, a molten carbonate fuel cell can be operated to have a TFCE (and/or combined electrical efficiency and chemical efficiency) of about 55% or more, for example, about 60% or more, or about 65% or more, or about 70% or more, or about 75% or more, or about 80% or more, or about 85% or more. It is noted that for a total fuel cell efficiency and/or combined electrical efficiency and chemical efficiency, any additional electricity generated from use of excess heat generated by the fuel cell can be excluded from the efficiency calculation.

In various aspects of the invention, the operation of the fuel cells can be characterized based on a desired electrical efficiency of about 40% or less and a desired total fuel cell efficiency of about 55% or more. Where fuel cells are operated to have a desired electrical efficiency and a desired total fuel cell efficiency, a molten carbonate fuel cell can be operated to have an electrical efficiency of about 40% or less with a TFCE of about 55% or more, for example, about 35% EE or less with about a TFCE of 60% or more, about 30% EE or less with about a TFCE of about 65% or more, about 25% EE or less with about a 70% TFCE or more, or about 20% EE or less with about a TFCE of 75% or more, about 15% EE or less with about a TFCE of 80% or more, or about 10% EE or less with about a TFCE of about 85% or more.

### DEFINITIONS

Syngas: In this description, syngas is defined as mixture of H₂ and CO in any ratio. Optionally, H₂O and/or CO₂ may be present in the syngas. Optionally, inert compounds (such as nitrogen) and residual reformable fuel compounds may be present in the syngas. If components other than H₂ and CO are present in the syngas, the combined volume percentage of H₂ and CO in the syngas can be at least 25 vol % relative to the total volume of the syngas, such as at least 40 vol %, or at least 50 vol %, or at least 60 vol %. Additionally or alternately, the combined volume percentage of H₂ and CO in the syngas can be 100 vol % or less, such as 95 vol % or less or 90 vol % or less.

Reformable fuel: A reformable fuel is defined as a fuel that contains carbon-hydrogen bonds that can be reformed to generate H₂. Hydrocarbons are examples of reformable fuels, as are other hydrocarbonaceous compounds such as alcohols. Although CO and H₂O can participate in a water gas shift reaction to form hydrogen, CO is not considered a reformable fuel under this definition.

Reformable hydrogen content: The reformable hydrogen content of a fuel is defined as the number of H₂ molecules that can be derived from a fuel by reforming the fuel and then driving the water gas shift reaction to completion to maximize H₂ production. It is noted that H₂ by definition has a reformable hydrogen content of 1, although H₂ itself is not defined as a reformable fuel herein. Similarly, CO has a reformable hydrogen content of 1. Although CO is not strictly reformable, driving the water gas shift reaction to completion will result in exchange of a CO for an H₂. As examples of reformable hydrogen content for reformable fuels, the reformable hydrogen content of methane is 4H₂ molecules while the reformable hydrogen content of ethane is 7H₂ molecules. More generally, if a fuel has the composition CxHyOz, then the reformable hydrogen content of the fuel at 100% reforming and water-gas shift is n(H₂ max reforming)=2x+y/2−z. Based on this definition, fuel utilization within a cell can then be expressed as n(H₂ ox)/n(H₂ max reforming) Of course, the reformable hydrogen content of a mixture of components can be determined based on the reformable hydrogen content of the individual components. The reformable hydrogen content of compounds that contain other heteroatoms, such as oxygen, sulfur or nitrogen, can also be calculated in a similar manner.

Oxidation Reaction: In this discussion, the oxidation reaction within the anode of a fuel cell is defined as the reaction corresponding to oxidation of H₂ by reaction with CO₃²⁻ to form H₂O and CO₂. It is noted that the reforming reaction within the anode, where a compound containing a carbon-hydrogen bond is converted into H₂ and CO or CO₂, is excluded from this definition of the oxidation reaction in the anode. The water-gas shift reaction is similarly outside of this definition of the oxidation reaction. It is further noted that references to a combustion reaction are defined as references to reactions where H₂ or a compound containing carbon-hydrogen bond(s) are reacted with O₂ to form H₂O and carbon oxides in a non-electrochemical burner, such as the combustion zone of a combustion-powered generator.

Aspects of the invention can adjust anode fuel parameters to achieve a desired operating range for the fuel cell. Anode fuel parameters can be characterized directly, and/or in relation to other fuel cell processes in the form of one or more ratios. For example, the anode fuel parameters can be controlled to achieve one or more ratios including a fuel utilization, a fuel cell heating value utilization, a fuel surplus ratio, a reformable fuel surplus ratio, a reformable hydrogen content fuel ratio, and combinations thereof.

Fuel utilization: Fuel utilization is an option for characterizing operation of the anode based on the amount of oxidized fuel relative to the reformable hydrogen content of an input stream can be used to define a fuel utilization for a fuel cell. In this discussion, “fuel utilization” is defined as the ratio of the amount of hydrogen oxidized in the anode for production of electricity (as described above) versus the reformable hydrogen content of the anode input (including any associated reforming stages). Reformable hydrogen content has been defined above as the number of H₂ molecules that can be derived from a fuel by reforming the fuel and then driving the water gas shift reaction to completion to maximize H₂ production. For example, each methane introduced into an anode and exposed to steam reforming conditions results in generation of the equivalent of 4H₂ molecules at max production. (Depending on the reforming and/or anode conditions, the reforming product can correspond to a non-water gas shifted product, where one or more of the H₂ molecules is present instead in the form of a CO molecule.) Thus, methane is defined as having a reformable hydrogen content of 4H₂ molecules. As another example, under this definition ethane has a reformable hydrogen content of 7H₂ molecules.

The utilization of fuel in the anode can also be characterized by defining a heating value utilization based on a ratio of the Lower Heating Value of hydrogen oxidized in the anode due to the fuel cell anode reaction relative to the Lower Heating Value of all fuel delivered to the anode and/or a reforming stage associated with the anode. The “fuel cell heating value utilization” as used herein can be computed using the flow rates and Lower Heating Value (LHV) of the fuel components entering and leaving the fuel cell anode. As such, fuel cell heating value utilization can be computed as (LHV(anode_in)−LHV(anode_out))/LHV(anode_in), where LHV(anode_in) and LHV(anode_out) refer to the LHV of the fuel components (such as H₂, CH₄, and/or CO) in the anode inlet and outlet streams or flows, respectively. In this definition, the LHV of a stream or flow may be computed as a sum of values for each fuel component in the input and/or output stream. The contribution of each fuel component to the sum can correspond to the fuel component's flow rate (e.g., mol/hr) multiplied by the fuel component's LHV (e.g., joules/mol).

Lower Heating Value: The lower heating value is defined as the enthalpy of combustion of a fuel component to vapor phase, fully oxidized products (e.g., vapor phase CO₂ and H₂O product). For example, any CO₂ present in an anode input stream does not contribute to the fuel content of the anode input, since CO₂ is already fully oxidized. For this definition, the amount of oxidation occurring in the anode due to the anode fuel cell reaction is defined as oxidation of H₂ in the anode as part of the electrochemical reaction in the anode, as defined above.

It is noted that, for the special case where the only fuel in the anode input flow is H₂, the only reaction involving a fuel component that can take place in the anode represents the conversion of H₂ into H₂O. In this special case, the fuel utilization simplifies to (H₂-rate-in minus H₂-rate-out)/H₂-rate-in. In such a case, H₂ would be the only fuel component, and so the H₂ LHV would cancel out of the equation. In the more general case, the anode feed may contain, for example, CH₄, H₂, and CO in various amounts. Because these species can typically be present in different amounts in the anode outlet, the summation as described above can be needed to determine the fuel utilization.

Alternatively or in addition to fuel utilization, the utilization for other reactants in the fuel cell can be characterized. For example, the operation of a fuel cell can additionally or alternately be characterized with regard to “CO₂ utilization” and/or “oxidant” utilization. The values for CO₂ utilization and/or oxidant utilization can be specified in a similar manner.

Fuel surplus ratio: Still another way to characterize the reactions in a molten carbonate fuel cell is by defining a utilization based on a ratio of the Lower Heating Value of all fuel delivered to the anode and/or a reforming stage associated with the anode relative to the Lower Heating Value of hydrogen oxidized in the anode due to the fuel cell anode reaction. This quantity will be referred to as a fuel surplus ratio. As such the fuel surplus ratio can be computed as (LHV (anode_in)/(LHV(anode_in)−LHV(anode_out)) where LHV(anode_in) and LHV(anode_out) refer to the LHV of the fuel components (such as H₂, CH₄, and/or CO) in the anode inlet and outlet streams or flows, respectively. In various aspects of the invention, a molten carbonate fuel cell can be operated to have a fuel surplus ratio of at least about 1.0, such as at least about 1.5, or at least about 2.0, or at least about 2.5, or at least about 3.0, or at least about 4.0. Additionally or alternately, the fuel surplus ratio can be about 25.0 or less.

It is noted that not all of the reformable fuel in the input stream for the anode may be reformed. Preferably, at least about 90% of the reformable fuel in the input stream to the anode (and/or into an associated reforming stage) can be reformed prior to exiting the anode, such as at least about 95% or at least about 98%. In some alternative aspects, the amount of reformable fuel that is reformed can be from about 75% to about 90%, such as at least about 80%.

The above definition for fuel surplus ratio provides a method for characterizing the amount of reforming occurring within the anode and/or reforming stage(s) associated with a fuel cell relative to the amount of fuel consumed in the fuel cell anode for generation of electric power.

Optionally, the fuel surplus ratio can be modified to account for situations where fuel is recycled from the anode output to the anode input. When fuel (such as H₂, CO, and/or unreformed or partially reformed hydrocarbons) is recycled from anode output to anode input, such recycled fuel components do not represent a surplus amount of reformable or reformed fuel that can be used for other purposes. Instead, such recycled fuel components merely indicate a desire to reduce fuel utilization in a fuel cell.

Reformable fuel surplus ratio: Calculating a reformable fuel surplus ratio is one option to account for such recycled fuel components is to narrow the definition of surplus fuel, so that only the LHV of reformable fuels is included in the input stream to the anode. As used herein the “reformable fuel surplus ratio” is defined as the Lower Heating Value of reformable fuel delivered to the anode and/or a reforming stage associated with the anode relative to the Lower Heating Value of hydrogen oxidized in the anode due to the fuel cell anode reaction. Under the definition for reformable fuel surplus ratio, the LHV of any H₂ or CO in the anode input is excluded. Such an LHV of reformable fuel can still be measured by characterizing the actual composition entering a fuel cell anode, so no distinction between recycled components and fresh components needs to be made. Although some non-reformed or partially reformed fuel may also be recycled, in most aspects the majority of the fuel recycled to the anode can correspond to reformed products such as H₂ or CO. Expressed mathematically, the reformable fuel surplus ratio (R_{RFS})=LHV_{RF}/LHV_{OH}, where LHV_{RF} is the Lower Heating Value (LHV) of the reformable fuel and LHV_{OH} is the Lower Heating Value (LHV) of the hydrogen oxidized in the anode. The LHV of the hydrogen oxidized in the anode may be calculated by subtracting the LHV of the anode outlet stream from the LHV of the anode inlet stream (e.g., LHV(anode_in)−LHV(anode_out)). In various aspects of the invention, a molten carbonate fuel cell can be operated to have a reformable fuel surplus ratio of at least about 0.25, such as at least about 0.5, or at least about 1.0, or at least about 1.5, or at least about 2.0, or at least about 2.5, or at least about 3.0, or at least about 4.0. Additionally or alternately, the reformable fuel surplus ratio can be about 25.0 or less. It is noted that this narrower definition based on the amount of reformable fuel delivered to the anode relative to the amount of oxidation in the anode can distinguish between two types of fuel cell operation methods that have low fuel utilization. Some fuel cells achieve low fuel utilization by recycling a substantial portion of the anode output back to the anode input. This recycle can allow any hydrogen in the anode input to be used again as an input to the anode. This can reduce the amount of reforming, as even though the fuel utilization is low for a single pass through the fuel cell, at least a portion of the unused fuel is recycled for use in a later pass. Thus, fuel cells with a wide variety of fuel utilization values may have the same ratio of reformable fuel delivered to the anode reforming stage(s) versus hydrogen oxidized in the anode reaction. In order to change the ratio of reformable fuel delivered to the anode reforming stages relative to the amount of oxidation in the anode, either an anode feed with a native content of non-reformable fuel needs to be identified, or unused fuel in the anode output needs to be withdrawn for other uses, or both.

Reformable hydrogen surplus ratio: Still another option for characterizing the operation of a fuel cell is based on a “reformable hydrogen surplus ratio.” The reformable fuel surplus ratio defined above is defined based on the lower heating value of reformable fuel components. The reformable hydrogen surplus ratio is defined as the reformable hydrogen content of reformable fuel delivered to the anode and/or a reforming stage associated with the anode relative to the hydrogen reacted in the anode due to the fuel cell anode reaction. As such, the “reformable hydrogen surplus ratio” can be computed as (RFC(reformable_anode_in)/(RFC(reformable_anode_in)−RFC(anode_out)), where RFC(reformable_anode_in) refers to the reformable hydrogen content of reformable fuels in the anode inlet streams or flows, while RFC (anode_out) refers to the reformable hydrogen content of the fuel components (such as H₂, CH₄, and/or CO) in the anode inlet and outlet streams or flows. The RFC can be expressed in moles/s, moles/hr, or similar. An example of a method for operating a fuel cell with a large ratio of reformable fuel delivered to the anode reforming stage(s) versus amount of oxidation in the anode can be a method where excess reforming is performed in order to balance the generation and consumption of heat in the fuel cell. Reforming a reformable fuel to form H₂ and CO is an endothermic process. This endothermic reaction can be countered by the generation of electrical current in the fuel cell, which can also produce excess heat corresponding (roughly) to the difference between the amount of heat generated by the anode oxidation reaction and the carbonate formation reaction and the energy that exits the fuel cell in the form of electric current. The excess heat per mole of hydrogen involved in the anode oxidation reaction/carbonate formation reaction can be greater than the heat absorbed to generate a mole of hydrogen by reforming. As a result, a fuel cell operated under conventional conditions can exhibit a temperature increase from inlet to outlet. Instead of this type of conventional operation, the amount of fuel reformed in the reforming stages associated with the anode can be increased. For example, additional fuel can be reformed so that the heat generated by the exothermic fuel cell reactions can be (roughly) balanced by the heat consumed in reforming, or even the heat consumed by reforming can be beyond the excess heat generated by the fuel oxidation, resulting in a temperature drop across the fuel cell. This can result in a substantial excess of hydrogen relative to the amount needed for electrical power generation. As one example, a feed to the anode inlet of a fuel cell or an associated reforming stage can be substantially composed of reformable fuel, such as a substantially pure methane feed. During conventional operation for electric power generation using such a fuel, a molten carbonate fuel cell can be operated with a fuel utilization of about 75%. This means that about 75% (or ¾) of the fuel content delivered to the anode is used to form hydrogen that is then reacted in the anode with carbonate ions to form H₂O and CO₂. In conventional operation, the remaining about 25% of the fuel content can be reformed to H₂ within the fuel cell (or can pass through the fuel cell unreacted for any CO or H₂ in the fuel), and then combusted outside of the fuel cell to form H₂O and CO₂ to provide heat for the cathode inlet to the fuel cell. The reformable hydrogen surplus ratio in this situation can be 4/(4−1)=4/3.

Electrical efficiency: As used herein, the term “electrical efficiency” (“EE”) is defined as the electrochemical power produced by the fuel cell divided by the rate of Lower Heating Value (“LHV”) of fuel input to the fuel cell. The fuel inputs to the fuel cell include fuel delivered to the anode, fuel delivered to the cathode, and any fuel used to maintain the temperature of the fuel cell, such as fuel delivered to a burner associated with a fuel cell. In this description, the power produced by the fuel may be described in terms of LHV(el) fuel rate.

Electrochemical power: As used herein, the term “electrochemical power” or LHV(el) is the power generated by the circuit connecting the cathode to the anode in the fuel cell and the transfer of carbonate ions across the fuel cell's electrolyte. Electrochemical power excludes power produced or consumed by equipment upstream or downstream from the fuel cell. For example, electricity produced from heat in a fuel cell exhaust stream is not considered part of the electrochemical power. Similarly, power generated by a gas turbine or other equipment upstream of the fuel cell is not part of the electrochemical power generated. The “electrochemical power” does not take electrical power consumed during operation of the fuel cell into account, or any loss incurred by conversion of the direct current to alternating current. In other words, electrical power used to supply the fuel cell operation or otherwise operate the fuel cell is not subtracted from the direct current power produced by the fuel cell. As used herein, the power density is the current density multiplied by voltage. As used herein, the total fuel cell power is the power density multiplied by the fuel cell area.

Fuel inputs: As used herein, the term “anode fuel input,” designated as LHV(anode_in), is the amount of fuel within the anode inlet stream. The term “fuel input”, designated as LHV(in), is the total amount of fuel delivered to the fuel cell, including a) the amount of fuel within the anode inlet stream, b) the amount of fuel within the cathode inlet stream, and c) the amount of fuel used to maintain the temperature of the fuel cell. The fuel may include both reformable and nonreformable fuels, based on the definition of a reformable fuel provided herein. Fuel input is not the same as fuel utilization.

Total fuel cell efficiency: As used herein, the term “total fuel cell efficiency” (“TFCE”) is defined as: the electrochemical power generated by the fuel cell, plus the rate of LHV of syngas produced by the fuel cell, divided by the rate of LHV of fuel input to the anode. In other words, TFCE=(LHV(el)+LHV(sg net))/LHV(anode_in), where LHV(anode_in) refers to rate at which the LHV of the fuel components (such as H₂, CH₄, and/or CO) delivered to the anode and LHV(sg net) refers to a rate at which syngas (H₂, CO) is produced in the anode, which is the difference between syngas input to the anode and syngas output from the anode. LHV(el) describes the electrochemical power generation of the fuel cell. The total fuel cell efficiency excludes heat generated by the fuel cell that is put to beneficial use outside of the fuel cell. In operation, heat generated by the fuel cell may be put to beneficial use by downstream equipment. For example, the heat may be used to generate additional electricity or to heat water. These uses, when they occur apart from the fuel cell, are not part of the total fuel cell efficiency, as the term is used in this application. The total fuel cell efficiency is for the fuel cell operation only, and does not include power production, or consumption, upstream, or downstream, of the fuel cell.

Chemical efficiency: As used herein, the term “chemical efficiency”, is defined as the lower heating value of H₂ and CO in the anode exhaust of the fuel cell, or LHV(sg out), divided by the fuel input, or LHV(in).

Neither the electrical efficiency nor the total system efficiency takes the efficiency of upstream or downstream processes into consideration. For example, it may be advantageous to use turbine exhaust as a source of CO₂ for the fuel cell cathode. In this arrangement, the efficiency of the turbine is not considered as part of the electrical efficiency or the total fuel cell efficiency calculation. Similarly, outputs from the fuel cell may be recycled as inputs to the fuel cell. A recycle loop is not considered when calculating electrical efficiency or the total fuel cell efficiency in single pass mode.

Steam to carbon ratio (S/C): As used herein, the steam to carbon ratio (S/C) is the molar ratio of steam in a flow to reformable carbon in the flow. Carbon in the form of CO and CO₂ are not included as reformable carbon in this definition. The steam to carbon ratio can be measured and/or controlled at different points in the system. For example, the composition of an anode inlet stream can be manipulated to achieve a S/C that is suitable for reforming in the anode. The S/C can be given as the molar flow rate of H₂O divided by the product of the molar flow rate of fuel multiplied by the number of carbon atoms in the fuel, e.g., one for methane. Thus, S/C=f_{H20}/(f_{CH4}×#C), where f_{H20} is the molar flow rate of water, where f_{CH4} is the molar flow rate of methane (or other fuel) and #C is the number of carbons in the fuel.

Fuel Cell and Fuel Cell Components: In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can represent a plurality of cells in an integrated unit. Although a fuel cell stack can include multiple fuel cells, the fuel cells can typically be connected in parallel and can function (approximately) as if they collectively represented a single fuel cell of a larger size. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the electrical currents in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (e.g., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

“Internal reforming” and “external reforming”: A fuel cell or fuel cell stack may include one or more internal reforming sections. As used herein, the term “internal reforming” refers to fuel reforming occurring within the body of a fuel cell, a fuel cell stack, or otherwise within a fuel cell assembly. External reforming, which is often used in conjunction with a fuel cell, occurs in a separate piece of equipment that is located outside of the fuel cell stack. In other words, the body of the external reformer is not in direct physical contact with the body of a fuel cell or fuel cell stack. In a typical set up, the output from the external reformer can be fed to the anode inlet of a fuel cell. Unless otherwise noted specifically, the reforming described within this application is internal reforming.

Internal reforming may occur within a fuel cell anode. Internal reforming can additionally or alternately occur within an internal reforming element integrated within a fuel cell assembly. The integrated reforming element may be located between fuel cell elements within a fuel cell stack. In other words, one of the trays in the stack can be a reforming section instead of a fuel cell element. In one aspect, the flow arrangement within a fuel cell stack directs fuel to the internal reforming elements and then into the anode portion of the fuel cells. Thus, from a flow perspective, the internal reforming elements and fuel cell elements can be arranged in series within the fuel cell stack. As used herein, the term “anode reforming” is fuel reforming that occurs within an anode. As used herein, the term “internal reforming” is reforming that occurs within an integrated reforming element and not in an anode section.

In some aspects, a reforming stage that is internal to a fuel cell assembly can be considered to be associated with the anode(s) in the fuel cell assembly. In some alternative aspects, for a reforming stage in a fuel cell stack that can be associated with an anode (such as associated with multiple anodes), a flow path can be available so that the output flow from the reforming stage is passed into at least one anode. This can correspond to having an initial section of a fuel cell plate not in contact with the electrolyte and instead can serve just as a reforming catalyst. Another option for an associated reforming stage can be to have a separate integrated reforming stage as one of the elements in a fuel cell stack, where the output from the integrated reforming stage can be returned to the input side of one or more of the fuel cells in the fuel cell stack.

From a heat integration standpoint, a characteristic height in a fuel cell stack can be the height of an individual fuel cell stack element. It is noted that the separate reforming stage and/or a separate endothermic reaction stage could have a different height in the stack than a fuel cell. In such a scenario, the height of a fuel cell element can be used as the characteristic height. In some aspects, an integrated endothermic reaction stage can be defined as a stage that is heat integrated with one or more fuel cells, so that the integrated endothermic reaction stage can use the heat from the fuel cells as a heat source for the endothermic reaction. Such an integrated endothermic reaction stage can be defined as being positioned less than 10 times the height of a stack element from any fuel cells providing heat to the integrated stage. For example, an integrated endothermic reaction stage (such as a reforming stage) can be positioned less than 10 times the height of a stack element from any fuel cells that are heat integrated, or less than 8 times the height of a stack element, or less than 5 times the height of a stack element, or less than 3 times the height of a stack element. In this discussion, an integrated reforming stage and/or integrated endothermic reaction stage that represent an adjacent stack element to a fuel cell element can be defined as being about one stack element height or less away from the adjacent fuel cell element.

In some aspects, a separate reforming stage that is heat integrated with a fuel cell element can correspond to a reforming stage associated with the fuel cell element. In such aspects, an integrated fuel cell element can provide at least a portion of the heat to the associated reforming stage, and the associated reforming stage can provide at least a portion of the reforming stage output to the integrated fuel cell as a fuel stream. In other aspects, a separate reforming stage can be integrated with a fuel cell for heat transfer without being associated with the fuel cell. In this type of situation, the separate reforming stage can receive heat from the fuel cell, but the decision can be made not to use the output of the reforming stage as an input to the fuel cell. Instead, the decision can be made to use the output of such a reforming stage for another purpose, such as directly adding the output to the anode exhaust stream, and/or for forming a separate output stream from the fuel cell assembly.

More generally, a separate stack element in a fuel cell stack can be used to perform any convenient type of endothermic reaction that can take advantage of the waste heat provided by integrated fuel cell stack elements. Instead of plates suitable for performing a reforming reaction on a hydrocarbon fuel stream, a separate stack element can have plates suitable for catalyzing another type of endothermic reaction. A manifold or other arrangement of inlet conduits in the fuel cell stack can be used to provide an appropriate input flow to each stack element. A similar manifold or other arrangement of outlet conduits can additionally or alternately be used to withdraw the output flows from each stack element. Optionally, the output flows from a endothermic reaction stage in a stack can be withdrawn from the fuel cell stack without having the output flow pass through a fuel cell anode. In such an optional aspect, the products of the exothermic reaction can therefore exit from the fuel cell stack without passing through a fuel cell anode. Examples of other types of endothermic reactions that can be performed in stack elements in a fuel cell stack can include, without limitation, ethanol dehydration to form ethylene and ethane cracking.

Recycle: As defined herein, recycle of a portion of a fuel cell output (such as an anode exhaust or a stream separated or withdrawn from an anode exhaust) to a fuel cell inlet can correspond to a direct or indirect recycle stream. A direct recycle of a stream to a fuel cell inlet is defined as recycle of the stream without passing through an intermediate process, while an indirect recycle involves recycle after passing a stream through one or more intermediate processes. For example, if the anode exhaust is passed through a CO₂ separation stage prior to recycle, this is considered an indirect recycle of the anode exhaust. If a portion of the anode exhaust, such as an H₂ stream withdrawn from the anode exhaust, is passed into a gasifier for converting coal into a fuel suitable for introduction into the fuel cell, then that is also considered an indirect recycle.

### Anode Inputs and Outputs

In various aspects of the invention, the MCFC array can be fed by a fuel received at the anode inlet that comprises, for example, both hydrogen and a hydrocarbon such as methane (or alternatively a hydrocarbonaceous or hydrocarbon-like compound that may contain heteroatoms different from C and H). Most of the methane (or other hydrocarbonaceous or hydrocarbon-like compound) fed to the anode can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane. The fuel source used can be shared with other components, such as a turbine that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate H₂, the molar ratio of water to fuel can be from about one to one to about ten to one, such as at least about two to one. A ratio of four to one or greater is typical for external reforming, but lower values can be typical for internal reforming To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an input stream for the anode of a molten carbonate fuel cell. Some fuel streams can correspond to streams containing hydrocarbons and/or hydrocarbon-like compounds that may also include heteroatoms different from C and H. In this discussion, unless otherwise specified, a reference to a fuel stream containing hydrocarbons for an MCFC anode is defined to include fuel streams containing such hydrocarbon-like compounds. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be at least about 1 vol %, such as at least about 2 vol %, or at least about 5 vol %, or at least about 10 vol %, or at least about 15 vol %, or at least about 20 vol %, or at least about 25 vol %, or at least about 30 vol %, or at least about 35 vol %, or at least about 40 vol %, or at least about 45 vol %, or at least about 50 vol %, or at least about 75 vol %. Additionally or alternately, the amount of CO₂ and/or inert compounds in a fuel stream for a molten carbonate fuel cell can be about 90 vol % or less, such as about 75 vol % or less, or about 60 vol % or less, or about 50 vol % or less, or about 40 vol % or less, or about 35 vol % or less.

Yet other examples of potential sources for an anode input stream can correspond to refinery and/or other industrial process output streams. For example, coking is a common process in many refineries for converting heavier compounds to lower boiling ranges. Coking typically produces an off-gas containing a variety of compounds that are gases at room temperature, including CO and various C1-C4 hydrocarbons. This off-gas can be used as at least a portion of an anode input stream. Other refinery off-gas streams can additionally or alternately be suitable for inclusion in an anode input stream, such as light ends (C1-C4) generated during cracking or other refinery processes. Still other suitable refinery streams can additionally or alternately include refinery streams containing CO or CO₂ that also contain H₂ and/or reformable fuel compounds.

Still other potential sources for an anode input can additionally or alternately include streams with increased water content. For example, an ethanol output stream from an ethanol plant (or another type of fermentation process) can include a substantial portion of H₂O prior to final distillation. Such H₂O can typically cause only minimal impact on the operation of a fuel cell. Thus, a fermentation mixture of alcohol (or other fermentation product) and water can be used as at least a portion of an anode input stream.

Biogas, or digester gas, is another additional or alternate potential source for an anode input. Biogas may primarily comprise methane and CO₂ and is typically produced by the breakdown or digestion of organic matter. Anaerobic bacteria may be used to digest the organic matter and produce the biogas. Impurities, such as sulfur-containing compounds, may be removed from the biogas prior to use as an anode input.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

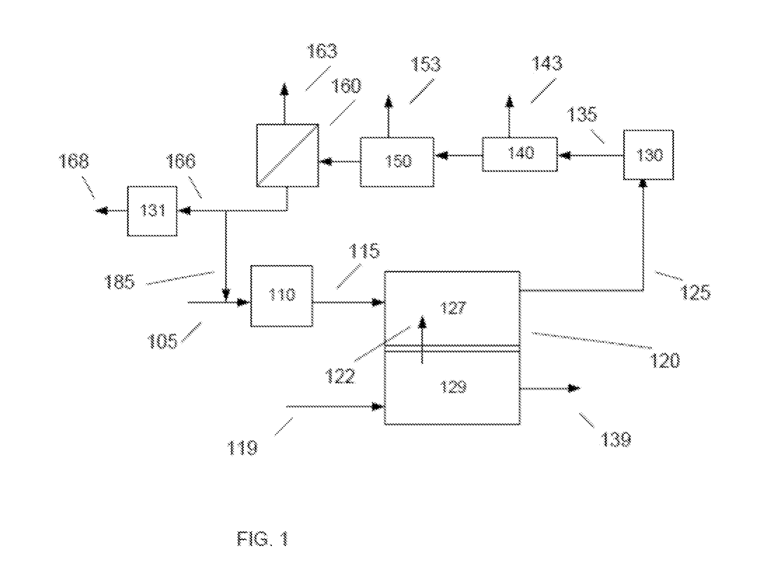

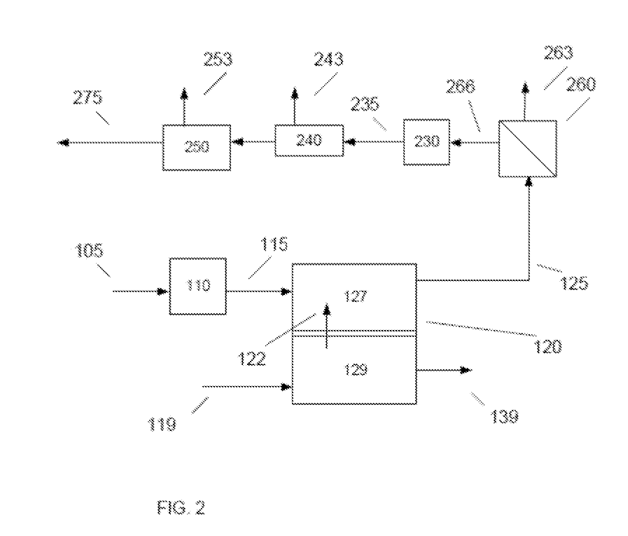

The anode exhaust can be subjected to a variety of gas processing options, including water-gas shift and separation of the components from each other. Two general anode processing schemes are shown in FIGS. 1 and 2.

FIG. 1 schematically shows an example of a reaction system for operating a fuel cell array of molten carbonate fuel cells in conjunction with a chemical synthesis process. In FIG. 1, a fuel stream 105 is provided to a reforming stage (or stages) 110 associated with the anode 127 of a fuel cell 120, such as a fuel cell that is part of a fuel cell stack in a fuel cell array. The reforming stage 110 associated with fuel cell 120 can be internal to a fuel cell assembly. In some optional aspects, an external reforming stage (not shown) can also be used to reform a portion of the reformable fuel in an input stream prior to passing the input stream into a fuel cell assembly. Fuel stream 105 can preferably include a reformable fuel, such as methane, other hydrocarbons, and/or other hydrocarbon-like compounds such as organic compounds containing carbon-hydrogen bonds. Fuel stream 105 can also optionally contain H₂ and/or CO, such as H₂ and/or CO provided by optional anode recycle stream 185. It is noted that anode recycle stream 185 is optional, and that in many aspects no recycle stream is provided from the anode exhaust 125 back to anode 127, either directly or indirectly via combination with fuel stream 105 or reformed fuel stream 115. After reforming, the reformed fuel stream 115 can be passed into anode 127 of fuel cell 120. A CO₂ and O₂— containing stream 119 can also be passed into cathode 129. A flow of carbonate ions 122, CO₃²⁻, from the cathode portion 129 of the fuel cell can provide the remaining reactant needed for the anode fuel cell reactions. Based on the reactions in the anode 127, the resulting anode exhaust 125 can include H₂O, CO₂, one or more components corresponding to incompletely reacted fuel (H₂, CO, CH₄, or other components corresponding to a reformable fuel), and optionally one or more additional nonreactive components, such as N₂ and/or other contaminants that are part of fuel stream 105. The anode exhaust 125 can then be passed into one or more separation stages. For example, a CO₂ removal stage 140 can correspond to a cryogenic CO₂ removal system, an amine wash stage for removal of acid gases such as CO₂, or another suitable type of CO₂ separation stage for separating a CO₂ output stream 143 from the anode exhaust. Optionally, the anode exhaust can first be passed through a water gas shift reactor 130 to convert any CO present in the anode exhaust (along with some H₂O) into CO₂ and H₂ in an optionally water gas shifted anode exhaust 135. Depending on the nature of the CO₂ removal stage, a water condensation or removal stage 150 may be desirable to remove a water output stream 153 from the anode exhaust. Though shown in FIG. 1 after the CO₂ separation stage 140, it may optionally be located before the CO₂ separation stage 140 instead. Additionally, an optional membrane separation stage 160 for separation of H₂ can be used to generate a high purity permeate stream 163 of H₂. The resulting retentate stream 166 can then be used as an input to a chemical synthesis process. Stream 166 could additionally or alternately be shifted in a second water-gas shift reactor 131 to adjust the H₂, CO, and CO₂ content to a different ratio, producing an output stream 168 for further use in a chemical synthesis process. In FIG. 1, anode recycle stream 185 is shown as being withdrawn from the retentate stream 166, but the anode recycle stream 185 could additionally or alternately be withdrawn from other convenient locations in or between the various separation stages. The separation stages and shift reactor(s) could additionally or alternately be configured in different orders, and/or in a parallel configuration. Finally, a stream with a reduced content of CO₂ 139 can be generated as an output from cathode 129. For the sake of simplicity, various stages of compression and heat addition/removal that might be useful in the process, as well as steam addition or removal, are not shown.

As noted above, the various types of separations performed on the anode exhaust can be performed in any convenient order. FIG. 2 shows an example of an alternative order for performing separations on an anode exhaust. In FIG. 2, anode exhaust 125 can be initially passed into separation stage 260 for removing a portion 263 of the hydrogen content from the anode exhaust 125. This can allow, for example, reduction of the H₂ content of the anode exhaust to provide a retentate 266 with a ratio of H₂ to CO closer to 2:1. The ratio of H₂ to CO can then be further adjusted to achieve a desired value in a water gas shift stage 230. The water gas shifted output 235 can then pass through CO₂ separation stage 240 and water removal stage 250 to produce an output stream 275 suitable for use as an input to a desired chemical synthesis process. Optionally, output stream 275 could be exposed to an additional water gas shift stage (not shown). A portion of output stream 275 can optionally be recycled (not shown) to the anode input. Of course, still other combinations and sequencing of separation stages can be used to generate a stream based on the anode output that has a desired composition. For the sake of simplicity, various stages of compression and heat addition/removal that might be useful in the process, as well as steam addition or removal, are not shown.

### Cathode Inputs and Outputs

Conventionally, a molten carbonate fuel cell can be operated based on drawing a desired load while consuming some portion of the fuel in the fuel stream delivered to the anode. The voltage of the fuel cell can then be determined by the load, fuel input to the anode, air and CO₂ provided to the cathode, and the internal resistances of the fuel cell. The CO₂ to the cathode can be conventionally provided in part by using the anode exhaust as at least a part of the cathode input stream. By contrast, the present invention can use separate/different sources for the anode input and cathode input. By removing any direct link between the composition of the anode input flow and the cathode input flow, additional options become available for operating the fuel cell, such as to generate excess synthesis gas, to improve capture of carbon dioxide, and/or to improve the total efficiency (electrical plus chemical power) of the fuel cell, among others.

In a molten carbonate fuel cell, the transport of carbonate ions across the electrolyte in the fuel cell can provide a method for transporting CO₂ from a first flow path to a second flow path, where the transport method can allow transport from a lower concentration (the cathode) to a higher concentration (the anode), which can thus facilitate capture of CO₂. Part of the selectivity of the fuel cell for CO₂ separation can be based on the electrochemical reactions allowing the cell to generate electrical power. For nonreactive species (such as N₂) that effectively do not participate in the electrochemical reactions within the fuel cell, there can be an insignificant amount of reaction and transport from cathode to anode. By contrast, the potential (voltage) difference between the cathode and anode can provide a strong driving force for transport of carbonate ions across the fuel cell. As a result, the transport of carbonate ions in the molten carbonate fuel cell can allow CO₂ to be transported from the cathode (lower CO₂ concentration) to the anode (higher CO₂ concentration) with relatively high selectivity. However, a challenge in using molten carbonate fuel cells for carbon dioxide removal can be that the fuel cells have limited ability to remove carbon dioxide from relatively dilute cathode feeds. The voltage and/or power generated by a carbonate fuel cell can start to drop rapidly as the CO₂ concentration falls below about 1.0 mole %. As the CO₂ concentration drops further, e.g., to below about 0.3 vol %, at some point the voltage across the fuel cell can become low enough that little or no further transport of carbonate may occur and the fuel cell ceases to function. Thus, at least some CO₂ is likely to be present in the exhaust gas from the cathode stage of a fuel cell under commercially viable operating conditions.

The amount of carbon dioxide delivered to the fuel cell cathode(s) can be determined based on the CO₂ content of a source for the cathode inlet and/or the amount of carbon-containing fuel in the cathode inlet stream. For a cathode inlet stream containing a carbon-containing fuel, an amount of CO₂ can be generated in-situ in the cathode that is proportional to the vol % of fuel in the cathode inlet stream multiplied by the average number of carbons in the fuel compounds. For example, H₂ has zero carbons, CO and CH₄ have one carbon, ethane has two carbons, and so on. As a result, the amount of CO₂ provided to the cathode by combustion of fuel can range from no CO₂ (if all of the fuel in the cathode is H₂) to a range of about 0.25 vol % to about 10 vol %. The upper end of the range of CO₂ derived from combusted fuel represents a situation where a substantial portion of the fuel corresponds to aromatic compounds and/or other fuels with multiple carbons. The CO₂ content of the cathode inlet stream derived from combustion of fuel can be in addition to any CO₂ present in the cathode inlet stream as the stream enters the cathode.

One example of a suitable CO₂-containing stream for use as a cathode input flow can be an output or exhaust flow from a combustion source. Examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air). To a first approximation, the CO₂ content of the output flow from a combustion source can be a minor portion of the flow. Even for a higher CO₂ content exhaust flow, such as the output from a coal-fired combustion source, the CO₂ content from most commercial coal-fired power plants can be about 15 vol % or less. More generally, the CO₂ content of an output or exhaust flow from a combustion source can be at least about 1.5 vol %, or at least about 1.6 vol %, or at least about 1.7 vol %, or at least about 1.8 vol %, or at least about 1.9 vol %, or at least greater 2 vol %, or at least about 4 vol %, or at least about 5 vol %, or at least about 6 vol %, or at least about 8 vol %. Additionally or alternately, the CO₂ content of an output or exhaust flow from a combustion source can be about 20 vol % or less, such as about 15 vol % or less, or about 12 vol % or less, or about 10 vol % or less, or about 9 vol % or less, or about 8 vol % or less, or about 7 vol % or less, or about 6.5 vol % or less, or about 6 vol % or less, or about 5.5 vol % or less, or about 5 vol % or less, or about 4.5 vol % or less. The concentrations given above are on a dry basis. It is noted that the lower CO₂ content values can be present in the exhaust from some natural gas or methane combustion sources, such as generators that are part of a power generation system that may or may not include an exhaust gas recycle loop.

Other potential sources for a cathode input stream can additionally or alternately include sources of bio-produced CO₂. This can include, for example, CO₂ generated during processing of bio-derived compounds, such as CO₂ generated during ethanol production. An additional or alternate example can include CO₂ generated by combustion of a bio-produced fuel, such as combustion of lignocellulose. Still other additional or alternate potential CO₂ sources can correspond to output or exhaust streams from various industrial processes, such as CO₂-containing streams generated by plants for manufacture of steel, cement, and/or paper.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

For various types of CO₂-containing streams from sources other than combustion sources, the CO₂ content of the stream can vary widely. The CO₂ content of an input stream to a cathode can contain at least about 2 vol % of CO₂, such as at least about 4 vol %, or at least about 5 vol %, or at least about 6 vol %, or at least about 8 vol %. Additionally or alternately, the CO₂ content of an input stream to a cathode can be about 30 vol % or less, such as about 25 vol % or less, or about 20 vol % or less, or about 15 vol % or less, or about 10 vol % or less, or about 8 vol % or less, or about 6 vol % or less, or about 4 vol % or less. For some still higher CO₂ content streams, the CO₂ content can be greater than about 30 vol %, such as a stream substantially composed of CO₂ with only incidental amounts of other compounds. As an example, a gas-fired turbine without exhaust gas recycle can produce an exhaust stream with a CO₂ content of approximately 4.2 vol %. With exhaust gas recycle, a gas-fired turbine can produce an exhaust stream with a CO₂ content of about 6-8 vol %. Stoichiometric combustion of methane can produce an exhaust stream with a CO₂ content of about 11 vol %. Combustion of coal can produce an exhaust stream with a CO₂ content of about 15-20 vol %. Fired heaters using refinery off-gas can produce an exhaust stream with a CO₂ content of about 12-15 vol %. A gas turbine operated on a low BTU gas without any exhaust gas recycle can produce an exhaust stream with a CO₂ content of ˜12 vol %.

In addition to CO₂, a cathode input stream must include O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of about 20 vol % or less, such as about 15 vol % or less, or about 10 vol % or less. Additionally or alternately, the oxygen content of the cathode input stream can be at least about 4 vol %, such as at least about 6 vol %, or at least about 8 vol %. More generally, a cathode input stream can have a suitable content of oxygen for performing the cathode reaction. In some aspects, this can correspond to an oxygen content of about 5 vol % to about 15 vol %, such as from about 7 vol % to about 9 vol %. For many types of cathode input streams, the combined amount of CO₂ and O₂ can correspond to less than about 21 vol % of the input stream, such as less than about 15 vol % of the stream or less than about 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be at least about 78 vol %, e.g., at least about 88 vol %, and/or about 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants.

In addition to the reaction to form carbonate ions for transport across the electrolyte, the conditions in the cathode can also be suitable for conversion of nitrogen oxides into nitrate and/or nitrate ions. Hereinafter, only nitrate ions will be referred to for convenience. The resulting nitrate ions can also be transported across the electrolyte for reaction in the anode. NOx concentrations in a cathode input stream can typically be on the order of ppm, so this nitrate transport reaction can have a minimal impact on the amount of carbonate transported across the electrolyte. However, this method of NOx removal can be beneficial for cathode input streams based on combustion exhausts from gas turbines, as this can provide a mechanism for reducing NOx emissions. The conditions in the cathode can additionally or alternately be suitable for conversion of unburned hydrocarbons (in combination with O₂ in the cathode input stream) to typical combustion products, such as CO₂ and H₂O.

A suitable temperature for operation of an MCFC can be between about 450° C. and about 750° C., such as at least about 500° C., e.g., with an inlet temperature of about 550° C. and an outlet temperature of about 625° C. Prior to entering the cathode, heat can be added to or removed from the combustion exhaust, if desired, e.g., to provide heat for other processes, such as reforming the fuel input for the anode. For example, if the source for the cathode input stream is a combustion exhaust stream, the combustion exhaust stream may have a temperature greater than a desired temperature for the cathode inlet. In such an aspect, heat can be removed from the combustion exhaust prior to use as the cathode input stream. Alternatively, the combustion exhaust could be at very low temperature, for example after a wet gas scrubber on a coal-fired boiler, in which case the combustion exhaust can be below about 100° C. Alternatively, the combustion exhaust could be from the exhaust of a gas turbine operated in combined cycle mode, in which the gas can be cooled by raising steam to run a steam turbine for additional power generation. In this case, the gas can be below about 50° C. Heat can be added to a combustion exhaust that is cooler than desired.

### Molten Carbonate Fuel Cell Operation

In some aspects, a fuel cell may be operated in a single pass or once-through mode. In single pass mode, reformed products in the anode exhaust are not returned to the anode inlet. Thus, recycling syngas, hydrogen, or some other product from the anode output directly to the anode inlet is not done in single pass operation. More generally, in single pass operation, reformed products in the anode exhaust are also not returned indirectly to the anode inlet, such as by using reformed products to process a fuel stream subsequently introduced into the anode inlet. Optionally, CO₂ from the anode outlet can be recycled to the cathode inlet during operation of an MCFC in single pass mode. More generally, in some alternative aspects, recycling from the anode outlet to the cathode inlet may occur for an MCFC operating in single pass mode. Heat from the anode exhaust or output may additionally or alternately be recycled in a single pass mode. For example, the anode output flow may pass through a heat exchanger that cools the anode output and warms another stream, such as an input stream for the anode and/or the cathode. Recycling heat from anode to the fuel cell is consistent with use in single pass or once-through operation. Optionally but not preferably, constituents of the anode output may be burned to provide heat to the fuel cell during single pass mode.

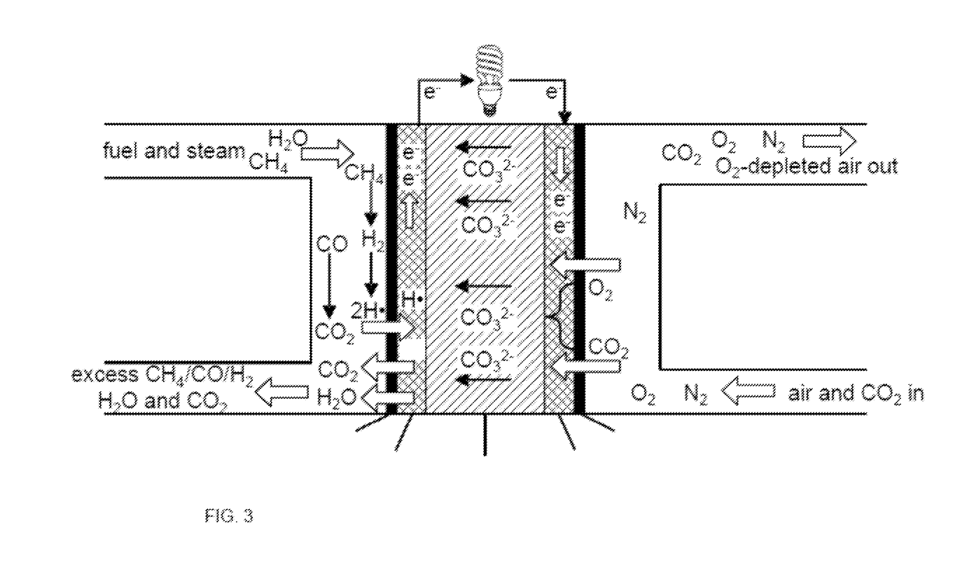

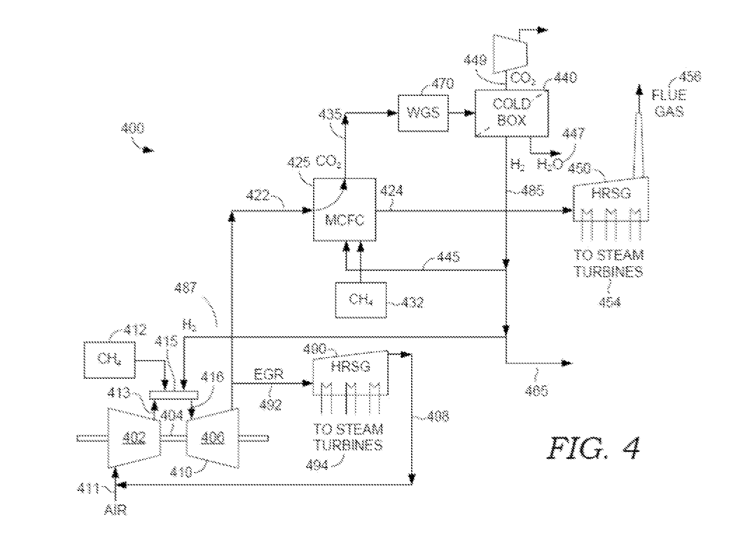

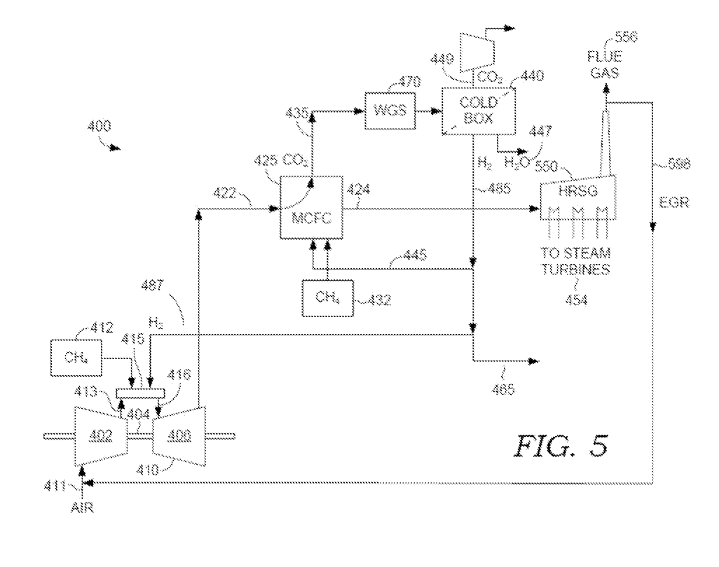

FIG. 3 shows a schematic example of the operation of an MCFC for generation of electrical power. In FIG. 3, the anode portion of the fuel cell can receive fuel and steam (H₂O) as inputs, with outputs of water, CO₂, and optionally excess H₂, CH₄ (or other hydrocarbons), and/or CO. The cathode portion of the fuel cell can receive CO₂ and some oxidant (e.g., air/O₂) as inputs, with an output corresponding to a reduced amount of CO₂ in O₂-depleted oxidant (air). The cathode portion can also receive one or more fuel compounds as part of the inlet stream that can be combusted to generate heat, CO₂, and H₂O. Within the fuel cell, CO₃²⁻ ions formed in the cathode side can be transported across the electrolyte to provide the carbonate ions needed for the reactions occurring at the anode.

Several reactions can occur within a molten carbonate fuel cell such as the example fuel cell shown in FIG. 3. The reforming reactions can be optional, and can be reduced or eliminated if sufficient H₂ is provided directly to the anode. The following reactions are based on CH₄, but similar reactions can occur when other fuels are used in the fuel cell.

<anode reforming>CH₄+H₂O=>3H₂+CO (1)

<water gas shift>CO+H₂O=>H₂+CO₂ (2)

<reforming and water gas shift combined>CH₄+2H₂O=>4H₂+CO₂ (3)

<anode H₂ oxidation>H₂+CO₃²⁻=>H₂O+CO₂+2e⁻ (4)

<cathode>½O₂+CO₂+2e⁻=>CO₃²⁻ (5)

Reaction (1) represents the basic hydrocarbon reforming reaction to generate H₂ for use in the anode of the fuel cell. The CO formed in reaction (1) can be converted to H₂ by the water-gas shift reaction (2). The combination of reactions (1) and (2) is shown as reaction (3). Reactions (1) and (2) can occur external to the fuel cell, and/or the reforming can be performed internal to the anode.

Reactions (4) and (5), at the anode and cathode respectively, represent the reactions that can result in electrical power generation within the fuel cell. Reaction (4) combines H₂, either present in the feed or optionally generated by reactions (1) and/or (2), with carbonate ions to form H₂O, CO₂, and electrons to the circuit. Reaction (5) combines O₂, CO₂, and electrons from the circuit to form carbonate ions. The carbonate ions generated by reaction (5) can be transported across the electrolyte of the fuel cell to provide the carbonate ions needed for reaction (4). In combination with the transport of carbonate ions across the electrolyte, a closed current loop can then be formed by providing an electrical connection between the anode and cathode.

In various embodiments, a goal of operating the fuel cell can be to improve the total efficiency of the fuel cell and/or the total efficiency of the fuel cell plus an integrated chemical synthesis process. This is typically in contrast to conventional operation of a fuel cell, where the goal can be to operate the fuel cell with high electrical efficiency for using the fuel provided to the cell for generation of electrical power. As defined above, total fuel cell efficiency may be determined by dividing the electric output of the fuel cell plus the lower heating value of the fuel cell outputs by the lower heating value of the input components for the fuel cell. In other words, TFCE=(LHV(el)+LHV(sg out))/LHV(in), where LHV(in) and LHV(sg out) refer to the LHV of the fuel components (such as H₂, CH₄, and/or CO) delivered to the fuel cell and syngas (H₂, CO and/or CO₂) in the anode outlet streams or flows, respectively. This can provide a measure of the electric energy plus chemical energy generated by the fuel cell and/or the integrated chemical process. It is noted that under this definition of total efficiency, heat energy used within the fuel cell and/or used within the integrated fuel cell/chemical synthesis system can contribute to total efficiency. However, any excess heat exchanged or otherwise withdrawn from the fuel cell or integrated fuel cell/chemical synthesis system is excluded from the definition. Thus, if excess heat from the fuel cell is used, for example, to generate steam for electricity generation by a steam turbine, such excess heat is excluded from the definition of total efficiency.

### Integration Example

### Applications for Integration with Combustion Turbines

In some aspects of the invention, a combustion source for generating power and exhausting a CO₂-containing exhaust can be integrated with the operation of molten carbonate fuel cells. An example of a suitable combustion source is a gas turbine. Preferably, the gas turbine can combust natural gas, methane gas, or another hydrocarbon gas in a combined cycle mode integrated with steam generation and heat recovery for additional efficiency. Modern natural gas combined cycle efficiencies are about 60% for the largest and newest designs. The resulting CO₂-containing exhaust gas stream can be produced at an elevated temperature compatible with the MCFC operation, such as 300° C.-700° C. and preferably 500° C.-650° C. The gas source can optionally but preferably be cleaned of contaminants such as sulfur that can poison the MCFC before entering the turbine. Alternatively, the gas source can be a coal-fired generator, wherein the exhaust gas would typically be cleaned post-combustion due to the greater level of contaminants in the exhaust gas. In such an alternative, some heat exchange to/from the gas may be necessary to enable clean-up at lower temperatures. In additional or alternate embodiments, the source of the CO₂-containing exhaust gas can be the output from a boiler, combustor, or other heat source that burns carbon-rich fuels. In other additional or alternate embodiments, the source of the CO₂-containing exhaust gas can be bio-produced CO₂ in combination with other sources.

In some aspects, the operation of a combustion source can be modified to take advantage of the ability of a cathode to combust fuel in the cathode inlet stream. For a conventional combustion reaction, a typical goal can be to combust substantially all of the fuel delivered to the combustion reaction zone. This can simplify processing of the exhaust, as little or no fuel remains in the combustion exhaust. However, running a combustion reaction zone to achieve substantially complete combustion does not necessarily correspond to the most efficient way to operate a combustion zone. Instead, it could be desirable to operate a combustion zone to have a residual fuel content after combustion in order to improve the overall efficiency of the combustion reaction. Conventionally such residual fuel would likely be wasted, due to the low concentration of fuel in the combustion exhaust. Additionally, the wasted fuel would become a pollutant, or require pollution control devices to eliminate. However, when a molten carbonate fuel cell is used to process such an exhaust, the residual fuel can be used to generate additional CO₂, generate additional heat for the fuel cell, or a combination thereof while acting as the pollution control device. The amount of fuel remaining in a combustion exhaust that is then used at least in part as a portion of the cathode inlet stream for a fuel cell can be at least about 0.5 vol %, or at least about 1.0 vol %, and up to about 5.0 vol % or less, as previously described for the fuel content of a cathode inlet stream.

For integration with a combustion source, some alternative configurations for processing of a fuel cell anode can be desirable. For example, an alternative configuration can be to recycle at least a portion of the exhaust from a fuel cell anode to the input of a fuel cell anode. The output stream from an MCFC anode can include H₂O, CO₂, optionally CO, and optionally but typically unreacted fuel (such as H₂ or CH₄) as the primary output components. Instead of using this output stream as an external fuel stream and/or an input stream for integration with another process, one or more separations can be performed on the anode output stream in order to separate the CO₂ from the components with potential fuel value, such as H₂ or CO. The components with fuel value can then be recycled to the input of an anode.

This type of configuration can provide one or more benefits. First, CO₂ can be separated from the anode output, such as by using a cryogenic CO₂ separator. Several of the components of the anode output (H₂, CO, CH₄) are not easily condensable components, while CO₂ and H₂O can be separated individually as condensed phases. Depending on the embodiment, at least about 90 vol % of the CO₂ in the anode output can be separated to form a relatively high purity CO₂ output stream. Alternatively, in some aspects less CO₂ can be removed from the anode output, so that about 50 vol % to about 90 vol % of the CO₂ in the anode output can be separated out, such as about 80 vol % or less or about 70 vol % or less. After separation, the remaining portion of the anode output can correspond primarily to components with fuel value, as well as reduced amounts of CO₂ and/or H₂O. This portion of the anode output after separation can be recycled for use as part of the anode input, along with additional fuel. In this type of configuration, even though the fuel utilization in a single pass through the MCFC(s) may be low, the unused fuel can be advantageously recycled for another pass through the anode. As a result, the single-pass fuel utilization can be at a reduced level, while avoiding loss (exhaust) of unburned fuel to the environment.

Additionally or alternatively to recycling a portion of the anode exhaust to the anode input, another configuration option can be to use a portion of the anode exhaust as an input for a combustion reaction for a turbine or other combustion device, such as a boiler, furnace, and/or fired heater. The relative amounts of anode exhaust recycled to the anode input and/or as an input to the combustion device can be any convenient or desirable amount. If the anode exhaust is recycled to only one of the anode input and the combustion device, the amount of recycle can be any convenient amount, such as up to 100% of the portion of the anode exhaust remaining after any separation to remove CO₂ and/or H₂O. When a portion of the anode exhaust is recycled to both the anode input and the combustion device, the total recycled amount by definition can be 100% or less of the remaining portion of anode exhaust. Otherwise, any convenient split of the anode exhaust can be used. In various embodiments of the invention, the amount of recycle to the anode input can be at least about 10% of the anode exhaust remaining after separations, for example at least about 25%, at least about 40%, at least about 50%, at least about 60%, at least about 75%, or at least about 90%. Additionally or alternately in those embodiments, the amount of recycle to the anode input can be about 90% or less of the anode exhaust remaining after separations, for example about 75% or less, about 60% or less, about 50% or less, about 40% or less, about 25% or less, or about 10% or less. Further additionally or alternately, in various embodiments of the invention, the amount of recycle to the combustion device can be at least about 10% of the anode exhaust remaining after separations, for example at least about 25%, at least about 40%, at least about 50%, at least about 60%, at least about 75%, or at least about 90%. Additionally or alternately in those embodiments, the amount of recycle to the combustion device can be about 90% or less of the anode exhaust remaining after separations, for example about 75% or less, about 60% or less, about 50% or less, about 40% or less, about 25% or less, or about 10% or less.

In still other alternative aspects of the invention, the fuel for a combustion device can additionally or alternately be a fuel with an elevated quantity of components that are inert and/or otherwise act as a diluent in the fuel. CO₂ and N₂ are examples of components in a natural gas feed that can be relatively inert during a combustion reaction. When the amount of inert components in a fuel feed reaches a sufficient level, the performance of a turbine or other combustion source can be impacted. The impact can be due in part to the ability of the inert components to absorb heat, which can tend to quench the combustion reaction. Examples of fuel feeds with a sufficient level of inert components can include fuel feeds containing at least about 20 vol % CO₂, or fuel feeds containing at least about 40 vol % N₂, or fuel feeds containing combinations of CO₂ and N₂ that have sufficient inert heat capacity to provide similar quenching ability. (It is noted that CO₂ has a greater heat capacity than N₂, and therefore lower concentrations of CO₂ can have a similar impact as higher concentrations of N₂. CO₂ can also participate in the combustion reactions more readily than N₂, and in doing so remove H₂ from the combustion. This consumption of H₂ can have a large impact on the combustion of the fuel, by reducing the flame speed and narrowing the flammability range of the air and fuel mixture.) More generally, for a fuel feed containing inert components that impact the flammability of the fuel feed, the inert components in the fuel feed can be at least about 20 vol %, such as at least about 40 vol %, or at least about 50 vol %, or at least about 60 vol %. Preferably, the amount of inert components in the fuel feed can be about 80 vol % or less.

When a sufficient amount of inert components are present in a fuel feed, the resulting fuel feed can be outside of the flammability window for the fuel components of the feed. In this type of situation, addition of H₂ from a recycled portion of the anode exhaust to the combustion zone for the generator can expand the flammability window for the combination of fuel feed and H₂, which can allow, for example, a fuel feed containing at least about 20 vol % CO₂ or at least about 40% N₂ (or other combinations of CO₂ and N₂) to be successfully combusted.

Relative to a total volume of fuel feed and H₂ delivered to a combustion zone, the amount of H₂ for expanding the flammability window can be at least about 5 vol % of the total volume of fuel feed plus H₂, such as at least about 10 vol %, and/or about 25 vol % or less. Another option for characterizing the amount of H₂ to add to expand the flammability window can be based on the amount of fuel components present in the fuel feed before H₂ addition. Fuel components can correspond to methane, natural gas, other hydrocarbons, and/or other components conventionally viewed as fuel for a combustion-powered turbine or other generator. The amount of H₂ added to the fuel feed can correspond to at least about one third of the volume of fuel components (1:3 ratio of H_{z}:fuel component) in the fuel feed, such as at least about half of the volume of the fuel components (1:2 ratio). Additionally or alternately, the amount of H₂ added to the fuel feed can be roughly equal to the volume of fuel components in the fuel feed (1:1 ratio) or less. For example, for a feed containing about 30 vol % CH₄, about 10% N₂, and about 60% CO₂, a sufficient amount of anode exhaust can be added to the fuel feed to achieve about a 1:2 ratio of H₂ to CH₄. For an idealized anode exhaust that contained only H_{z}, addition of H₂ to achieve a 1:2 ratio would result in a feed containing about 26 vol % CH₄, 13 vol % H₂, 9 vol % N₂, and 52 vol % CO₂.

### Additional Embodiments

The invention can additionally or alternately include one or more of the following embodiments listed below.

### Embodiment 1

A method for producing electricity, the method comprising: introducing an anode fuel stream comprising a reformable fuel into an anode of a molten carbonate fuel cell, an internal reforming element associated with the anode of the molten carbonate fuel cell, or a combination thereof; introducing a cathode inlet stream comprising CO₂, O₂, and one or more fuel compounds into a cathode of the molten carbonate fuel cell, the one or more fuel compounds comprising H₂, one or more carbon-containing fuel compounds, or a combination thereof, a concentration of the one or more fuel compounds in the cathode inlet stream being at least about 0.01 vol %, the concentration of the one or more fuel compounds in the cathode inlet stream being less than an autoignition concentration for operating conditions in the cathode of the fuel cell; generating electricity within the molten carbonate fuel cell; generating an anode exhaust comprising H₂, CO, and CO₂; and generating a cathode exhaust comprising at least about 1 vol % O₂ and about 100 vppm or less of the one or more fuel compounds.

### Embodiment 2

The method of Embodiment 1, wherein a methylene-equivalent volume percentage of the one or more fuel compounds is at least about 0.02 vol %.

### Embodiment 3

The method of Embodiment 1 or 2, wherein the cathode of the molten carbonate fuel cell comprises an electrode surface and a secondary catalytic surface, the secondary catalytic surface comprising at least one Group VIII metal, the generating of the cathode exhaust comprising oxidizing at least a portion of the one or more fuel compounds in the presence of the secondary catalytic surface.

### Embodiment 4

A method for producing electricity, the method comprising: introducing an anode fuel stream comprising a reformable fuel into an anode of a molten carbonate fuel cell, an internal reforming element associated with the anode of the molten carbonate fuel cell, or a combination thereof; introducing a cathode inlet stream comprising CO₂, O₂, and one or more fuel compounds into a cathode of the molten carbonate fuel cell, the one or more fuel compounds comprising one or more aromatic compounds, one or more carbon-containing fuel compounds having at least 5 carbons, or a combination thereof, the one or more fuel compounds in the cathode inlet stream having a methylene-equivalent volume percentage of at least about 0.02 vol %, the concentration of the one or more fuel compounds in the cathode inlet stream being less than an autoignition concentration for operating conditions in the cathode of the fuel cell; generating electricity within the molten carbonate fuel cell; generating an anode exhaust comprising H₂, CO, and CO₂; and generating a cathode exhaust comprising at least about 1 vol % O₂, a methylene-equivalent volume percentage of the one or more fuel compounds being at least about 50% lower than the methylene-equivalent volume percentage of the cathode inlet stream, the methylene-equivalent volume percentage of the cathode exhaust optionally being about 0.01 vol % or less, wherein the cathode of the molten carbonate fuel cell comprises an electrode surface and a secondary catalytic surface, the secondary catalytic surface comprising at least one Group VIII metal, the generating of the cathode exhaust comprising oxidizing at least a portion of the one or more fuel compounds in the presence of the secondary catalytic surface.

### Embodiment 5

The method of Embodiment 3 or 4, wherein the at least one Group VIII metal comprises Ni, Pt, Pd, Co, Rh, Ru, Re, Ir, Fe or a combination thereof, preferably Ni, Co, Fe, Pt, Pd, or a combination thereof

### Embodiment 6

The method of any one of the previous embodiments, wherein a sulfur content of the cathode inlet stream is about 25 wppm or less, for example about 15 wppm or less.

### Embodiment 7

The method of any one of the previous embodiments, wherein the one or more fuel compounds in the cathode inlet stream include heteroatoms different from C, H, and O, a concentration of the heteroatoms different from C, H, and O being about 100 wppm or less relative to the weight of the one or more fuel compounds.

### Embodiment 8

The method of any one of the previous embodiments, wherein the cathode inlet stream comprises at least a portion of a combustion exhaust, the at least a portion of a combustion exhaust optionally comprising a methylene-equivalent volume percentage of at least about 0.02 vol % of one or more carbon-containing fuel compounds, the at least a portion of a combustion exhaust optionally being at least a portion of an exhaust from a gas turbine.

### Embodiment 9

The method of any one of the previous embodiments, wherein the molten carbonate fuel cell is operated at a thermal ratio of about 0.25 to about 1.3, for example from about 0.25 to about 1.0 or from about 0.4 to about 1.0.

### Embodiment 10

The method of any one of the previous embodiments, wherein an amount of the reformable fuel introduced into the anode of the molten carbonate fuel cell, a reforming stage associated with the anode of the molten carbonate fuel cell (optionally the internal reforming element), or the combination thereof, is at least about 75% greater than an amount of hydrogen reacted in the molten carbonate fuel cell to generate electricity.

### Embodiment 11

The method of any one of the previous embodiments, wherein a fuel utilization in the anode of the molten carbonate fuel cell is about 50% or less and a CO₂ utilization in the cathode of the molten carbonate fuel cell is at least about 60%.

### Embodiment 12

The method of any one of the previous embodiments, wherein an electrical efficiency for the molten carbonate fuel cell is between about 10% and about 40% and a total fuel cell efficiency for the molten carbonate fuel cell is at least about 55%.

### Embodiment 13

A molten carbonate fuel cell system comprising: a molten carbonate fuel cell having an anode and a cathode, the cathode comprising an electrode surface and a secondary catalytic surface comprising at least one Group VIII metal, a concentration of the at least one Group VIII metal on the secondary catalytic surface being lower in a first region of the secondary catalytic surface relative to a concentration of the at least one Group VIII metal in a second region of the secondary catalytic surface, the first region of the secondary catalytic surface being closer to a cathode inlet of the cathode of the molten carbonate fuel cell than the second region of the secondary catalytic surface.

### Embodiment 14

The method of Embodiment 13, wherein the at least one Group VIII metal comprises Ni, Pt, Pd, Co, Rh, Ru, Re, Ir, Fe, or a combination thereof, for example comprising at least Ni, Co, Fe, Pt, Pd, or a combination thereof

### Embodiment 15

The method of Embodiment 13 or 14, wherein a region of the secondary catalytic surface comprises a continuous increasing gradient of concentration of the at least one Group VIII metal.

### Embodiment 16

The method of any of Embodiments 13-15, wherein the first region of the secondary catalytic surface comprises at least one Group VIII metal and the second region of the secondary catalytic surface comprises at least one additional Group VIII metal different from the at least one Group VIII metal of the first region of the secondary catalytic surface.

### Embodiment 17

The method of any of Embodiments 13-15, wherein the second region of the secondary catalytic surface comprises at least one Group VIII metal and the first region of the secondary catalytic surface comprises at least one additional Group VIII metal different from the at least one Group VIII metal of the second region of the secondary catalytic surface.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

What is claimed is:

1. A method for producing electricity, the method comprising:
introducing an anode fuel stream comprising a reformable fuel into an anode of a molten carbonate fuel cell, an internal reforming element associated with the anode of the molten carbonate fuel cell, or a combination thereof;
introducing a cathode inlet stream comprising CO₂, O₂, and one or more fuel compounds into a cathode of the molten carbonate fuel cell, the one or more fuel compounds comprising H₂, CO, one or more carbon-containing fuel compounds, or a combination thereof, a concentration of the one or more fuel compounds in the cathode inlet stream being at least about 0.01 vol %, the concentration of the one or more fuel compounds in the cathode inlet stream being less than an autoignition concentration for operating conditions in the cathode of the fuel cell;
generating electricity within the molten carbonate fuel cell;
generating an anode exhaust comprising H₂, CO, and CO₂; and
generating a cathode exhaust comprising at least about 1 vol % O₂ and less than 100 vppm of the one or more fuel compounds.

2. The method of claim 1, wherein the cathode of the molten carbonate fuel cell comprises an electrode surface and a secondary catalytic surface, the secondary catalytic surface comprising at least one Group VIII metal, the generating of the cathode exhaust comprising oxidizing at least a portion of the one or more fuel compounds in the presence of the secondary catalytic surface.

3. The method of claim 1, wherein a methylene-equivalent volume percentage of the one or more fuel compounds is at least about 0.02 vol %.

4. The method of claim 1, wherein a sulfur content of the cathode inlet stream is about 25 wppm or less.

5. The method of claim 1, wherein the one or more fuel compounds in the cathode inlet stream include heteroatoms different from C, H, and O, a concentration of the heteroatoms different from C, H, and O being about 100 wppm or less relative to the weight of the one or more fuel compounds.

6. The method of claim 1, wherein the cathode inlet stream comprises at least a portion of a combustion exhaust.

7. The method of claim 6, wherein the at least a portion of a combustion exhaust comprises a methylene-equivalent volume percentage of at least about 0.02 vol % of a carbon-containing fuel compound.

8. The method of claim 6, wherein the at least a portion of a combustion exhaust comprises at least a portion of an exhaust from a gas turbine.

9. The method of claim 1, wherein the fuel cell is operated at a thermal ratio of about 0.25 to about 1.0.

10. The method of claim 1, wherein an amount of the reformable fuel introduced into the anode, a reforming stage associated with the anode, or the combination thereof, is at least about 75% greater than an amount of hydrogen reacted in the molten carbonate fuel cell to generate electricity.

11. The method of claim 1, wherein a fuel utilization in the anode is about 50% or less and a CO₂ utilization in the cathode is at least about 60%.

12. The method of claim 1, wherein an electrical efficiency for the fuel cell is between about 10% and about 40% and a total fuel cell efficiency for the fuel cell is at least about 55%.

13. A method for producing electricity, the method comprising:
introducing an anode fuel stream comprising a reformable fuel into an anode of a molten carbonate fuel cell, an internal reforming element associated with the anode of the molten carbonate fuel cell, or a combination thereof;
introducing a cathode inlet stream comprising CO₂, O₂, and one or more fuel compounds into a cathode of the molten carbonate fuel cell, the one or more fuel compounds comprising one or more aromatic compounds, one or more carbon-containing fuel compounds having at least 5 carbons, or a combination thereof, the one or more fuel compounds in the cathode inlet stream having a methylene-equivalent volume percentage of at least about 0.02 vol %, a concentration of the one or more fuel compounds in the cathode inlet stream being less than an autoignition concentration for operating conditions in the cathode of the fuel cell;
generating electricity within the molten carbonate fuel cell;
generating an anode exhaust comprising H₂, CO, and CO₂; and
generating a cathode exhaust comprising at least about 1 vol % O₂, a methylene-equivalent volume percentage of the one or more fuel compounds being at least about 50% lower than the methylene-equivalent volume percentage of the cathode inlet stream,
wherein the cathode of the molten carbonate fuel cell comprises an electrode surface and a secondary catalytic surface, the secondary catalytic surface comprising at least one Group VIII metal, the generating of the cathode exhaust comprising oxidizing at least a portion of the one or more fuel compounds in the presence of the secondary catalytic surface.

14. The method of claim 13, wherein the at least one Group VIII metal comprises Ni, Pt, Pd, Co, Rh, Ru, Re, Ir, Fe, or a combination thereof.

15. The method of claim 13, wherein the methylene-equivalent volume percentage of the cathode exhaust is about 0.01 vol % or less.

16. A molten carbonate fuel cell system comprising:
a molten carbonate fuel cell having an anode and a cathode, the cathode comprising an electrode surface and a secondary catalytic surface comprising at least one Group VIII metal, a concentration of the at least one Group VIII metal on the secondary catalytic surface being lower in a first region of the secondary catalytic surface relative to a concentration of the at least one Group VIII metal in a second region of the secondary catalytic surface, the first region of the secondary catalytic surface being closer to a cathode inlet of the cathode of the molten carbonate fuel cell than the second region of the secondary catalytic surface.

17. The method of claim 16, wherein the at least one Group VIII metal comprises Ni, Pt, Pd, Co, Rh, Ru, Re, Ir, Fe or a combination thereof.

18. The method of claim 16, wherein a region of the secondary catalytic surface comprises a continuous increasing gradient of concentration of the at least one Group VIII metal.

19. The method of claim 16, wherein the first region of the secondary catalytic surface comprises at least one Group VIII metal and the second region of the secondary catalytic surface comprises at least one additional Group VIII metal different from the at least one Group VIII metal of the first region of the secondary catalytic surface.

20. The method of claim 16, wherein the second region of the secondary catalytic surface comprises at least one Group VIII metal and the first region of the secondary catalytic surface comprises at least one additional Group VIII metal different from the at least one Group VIII metal of the second region of the secondary catalytic surface.
